(19) United States
(12) Patent Application Publication
(10) Pub. No.: US 2010/0328032 A1
(43) Pub. Date: Dec. 30, 2010

(54) SECURITY FOR COMPUTING UNIT WITH FEMTOCELL AP FUNCTIONALITY

(75) Inventor: Ahmadreza (Reza) Rofougaran, Newport Coast, CA (US)

Correspondence Address: GARLICK HARRISON & MARKISON, P.O. BOX 160727, AUSTIN, TX, 78716-0727, US

(73) Assignee: BROADCOM CORPORATION, Irvine, CA (US)

(21) Appl. No.: 12/490,523

(22) Filed: Jun. 24, 2009

(51) Int. Cl. G06F 7/04; H04M 1/66; G06F 3/041

(52) U.S. Cl. 340/5.82; 455/411; 345/173

(57) ABSTRACT

A computing unit includes a radio that communicates with at least one external station in a femtocell access point (AP) mode of operation. A processing module executes a plurality of applications including a femtocell application in the femtocell AP mode of operation and a multi-level security application that authenticates a user of the computing unit and that restricts access to the femtocell application based on the authentication of the user.

### CROSS REFERENCE TO RELATED APPLICATIONS

The present application is related to the following U.S. applications that are commonly assigned:

GRAPHICAL AUTHENTICATION FOR A PORTABLE DEVICE AND METHODS, having Ser. No. ______, filed on Jun. 17, 2009; and

COMPUTING UNIT WITH FEMTOCELL AP FUNCTIONALITY, having Ser. No. ______, filed on ______;

the contents of which are incorporated herein by reference thereto.

### STATEMENT REGARDING FEDERALLY SPONSORED RESEARCH OR DEVELOPMENT

NOT APPLICABLE

### INCORPORATION-BY-REFERENCE OF MATERIAL SUBMITTED ON A COMPACT DISC

NOT APPLICABLE

### BACKGROUND OF THE INVENTION

1. Technical Field of the Invention

This invention relates generally to communication systems and more particularly to computing devices used in such communication systems.

2. Description of Related Art

Communication systems are known to support wireless and wire lined communications between wireless and/or wire lined communication devices. Such communication systems range from national and/or international cellular telephone systems to the Internet to point-to-point in-home wireless networks to radio frequency identification (RFID) systems. Each type of communication system is constructed, and hence operates, in accordance with one or more communication standards. For instance, wireless communication systems may operate in accordance with one or more standards including, but not limited to, IEEE 802.11, IEEE 802.15.4, Bluetooth, global system for mobile communications (GSM), wideband code division multiplexing (WCDMA), enhanced data rates for GSM evolution (EDGE), universal mobile telecommunications system (UMTS), long term evolution (LTE), IEEE 802.16, evolution data optimized (EV-DO), and/or variations thereof.

Depending on the type of wireless communication system, a wireless communication device, such as a cellular telephone, two-way radio, personal digital assistant (PDA), personal computer (PC), laptop computer, home entertainment equipment, RFID reader, RFID tag, et cetera communicates directly or indirectly with other wireless communication devices. For direct communications (also known as point-to-point communications), the participating wireless communication devices tune their receivers and transmitters to the same channel or channels (e.g., one of the plurality of radio frequency (RF) carriers of the wireless communication system) and communicate over that channel(s). For indirect wireless communications, each wireless communication device communicates directly with an associated base station (e.g., for cellular services) and/or an associated access point (e.g., for an in-home or in-building wireless network) via an assigned channel. To complete a communication connection between the wireless communication devices, the associated base stations and/or associated access points communicate with each other directly, via a system controller, via the public switch telephone network, via the Internet, and/or via some other wide area network.

An issue arises for indirect wireless communications when one or more of the wireless communication devices are indoors. In this instance, the structure of a building impedes wireless transmissions, which decreases the wireless communication device's ability to communication with a base station or access point. To address this issue, the wireless communication industry is creating standards for the deployment of femtocells. In general, a femtocell is a small cellular base station designed for in-building use that connects to the core mobile network via the internet. A typical femtocell supports a small number of users (e.g., 2-6 cell phones).

As femtocells are introduced to the market, there are many deployment challenges. One challenge is producing economical femtocells. Another challenge is the portability of femtocells. For example, the size and transportability of a femtocell are issues that affect the ability to easily use a femtocell at various locations (home, office, on vacation, etc.). Other challenges include processing of cellular telephone calls, interference, etc.

Therefore, a need exists for a computing unit that includes femtocell functionality and that addresses one or more of the above challenges and/or other femtocell technological challenges and/or deployment challenges.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWING(S)

FIG. 1 is a schematic block diagram of an embodiment of a computing device in accordance with the present invention;

FIG. 2 is a schematic block diagram of an embodiment of a handheld computing unit coupled to an extended computing unit in accordance with the present invention;

FIG. 3 is a schematic block diagram of an embodiment of a handheld computing unit that is not coupled to an extended computing unit in accordance with the present invention;

FIG. 4 is a schematic block diagram of an embodiment of a femtocell access point (AP) in accordance with the present invention;

FIG. 5 is a schematic block diagram of an embodiment of a handheld computing unit and an extended computing unit in accordance with the present invention;

FIG. 6 is a schematic block diagram of an embodiment of a handheld computing unit and an extended computing unit implementing a femtocell AP in accordance with the present invention;

FIG. 7 is a schematic block diagram of another embodiment of a handheld computing unit and an extended computing unit implementing a femtocell AP in accordance with the present invention;

FIG. 8 is a schematic block diagram of another embodiment of a handheld computing unit and an extended computing unit implementing a femtocell AP in accordance with the present invention;

FIG. 9 is a schematic block diagram of another embodiment of a handheld computing unit and an extended computing unit implementing a femtocell AP in accordance with the present invention;

FIG. 10 is a schematic block diagram of another embodiment of a handheld computing unit and an extended computing unit in accordance with the present invention;

FIG. 11 is a schematic block diagram of another embodiment of a handheld computing unit and an extended computing unit in accordance with the present invention;

FIG. 12 is a schematic block diagram of another embodiment of a handheld computing unit and an extended computing unit implementing a femtocell AP in accordance with the present invention;

FIG. 13 is a schematic block diagram of an example of a handheld computing unit and an extended computing unit in a cellular mode in accordance with the present invention;

FIG. 14 is a schematic block diagram of an example of a handheld computing unit and an extended computing unit in a femtocell AP mode in accordance with the present invention;

FIG. 15 is a schematic block diagram of another example of a handheld computing unit and an extended computing unit in a femtocell AP mode in accordance with the present invention;

FIG. 16 is a schematic block diagram of another example of a handheld computing unit and an extended computing unit in accordance with the present invention;

FIG. 17 is a schematic block diagram of an embodiment of a portable device implementing graphical authentication in accordance with the present invention;

FIG. 18 is a schematic block diagram of another embodiment of a portable device implementing graphical authentication in accordance with the present invention;

FIG. 19 is a schematic block diagram of another embodiment of a portable device implementing graphical authentication in accordance with the present invention;

FIG. 20 is a schematic block diagram of another embodiment of a portable device implementing graphical authentication in accordance with the present invention;

FIG. 21 is a schematic block diagram of an embodiment of a portable device implementing a training mode in accordance with the present invention;

FIG. 22 is a schematic block diagram of an embodiment of a portable device implementing a training mode in accordance with the present invention;

FIG. 23 is a graphical representation of example touch screen data in accordance with the present invention;

FIG. 24 is a graphical representation of an example velocity profile and stored velocity profile in accordance with the present invention;

FIG. 25 is a graphical representation of an example normalized velocity profile and stored velocity profile in accordance with the present invention;

FIG. 26 is a schematic block diagram of security module 525 in accordance with an embodiment of the present invention;

FIG. 27 is a schematic block diagram of another embodiment of a portable device implementing biometric authentication in accordance with the present invention;

FIG. 28 is a schematic block diagram of security module 545 in accordance with an embodiment of the present invention;

FIG. 29 is a flowchart representation of an embodiment of a method in accordance with the present invention;

FIG. 30 is a flowchart representation of an embodiment of a method in accordance with the present invention;

FIG. 31 is a flowchart representation of an embodiment of a method in accordance with the present invention; and

FIG. 32 is a flowchart representation of an embodiment of a method in accordance with the present invention.

### DETAILED DESCRIPTION OF THE INVENTION

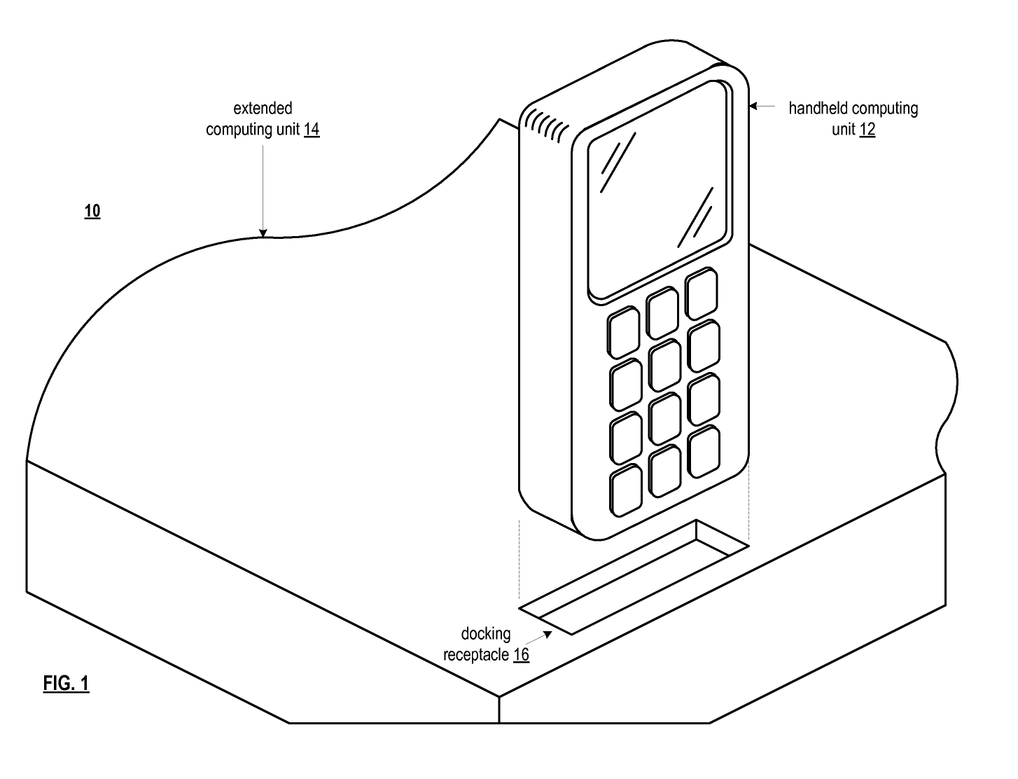

FIG. 1 is a diagram of an embodiment of a computing device 10 that includes a handheld computing unit 12 and an extended computing unit 14. The handheld computing unit 12 may have a form factor similar to a cellular telephone, personal digital assistant, personal digital audio/video player, etc. and includes a connector structure that couples to a docketing receptacle 16 of the extended computing unit 14 (e.g., collectively a docking interface). The connector structure and docketing receptacle may be wired (e.g., male and female connectors), wireless transceivers (e.g., Bluetooth, ZigBee, 60 GHz, etc.), and/or magnetic coils.

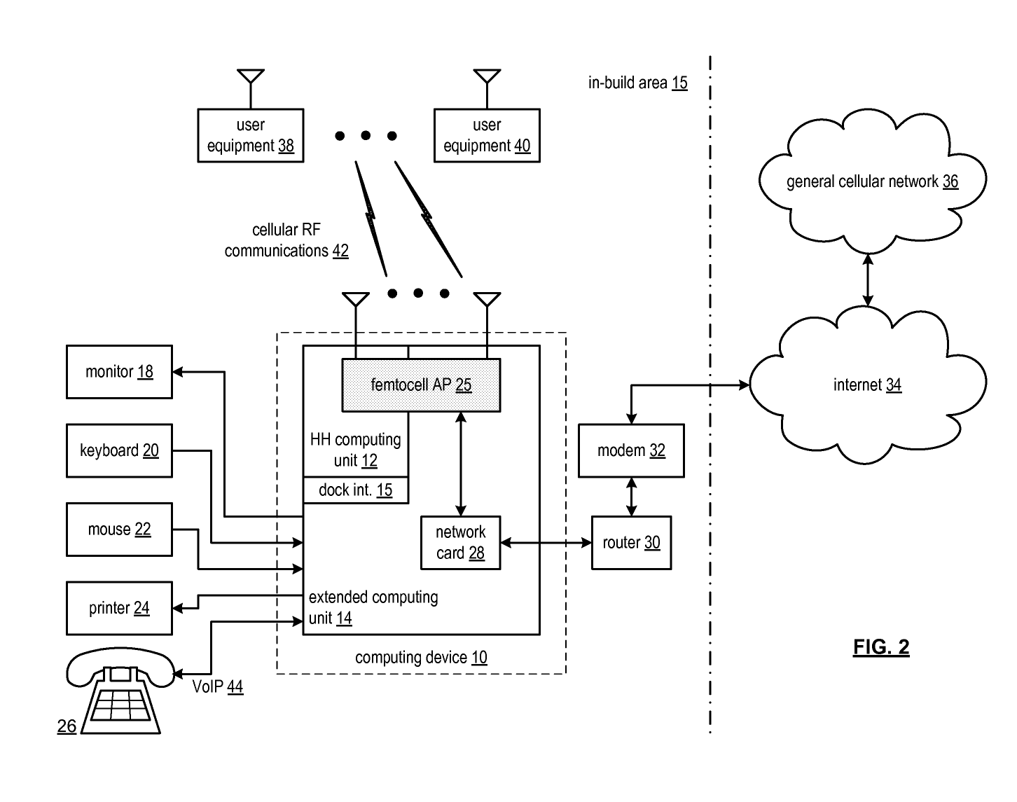

In general, the handheld computing unit 12 includes the primary processing module (e.g., central processing unit), the primary main memory, and the primary hard disk memory for the computing device 10. In this manner, the handheld computing unit 12 functions as the core of a personal computer (PC) or laptop computer when it is docked to the extended computing unit and functions as a cellular telephone, a GPS receiver, a personal digital audio player, a personal digital video player, a personal digital assistant, and/or other handheld electronic device when it is not docked to the extended computing unit. When the handheld computing unit 12 is docked to the extended computing unit 14, the computing device 10 may function as a femtocell access point (AP) as will be discussed below with reference to FIGS. 2-15.

In addition, when the handheld computing unit 12 is docked to the extended computing unit 14, files and/or applications can be swapped therebetween. For example, assume that the user of the computing device 10 has created a presentation using presentation software and both reside in memory of the extended computing unit 14. The user may elect to transfer the presentation file and the presentation software to memory of the handheld computing unit 12. If the handheld computing unit 12 has sufficient memory to store the presentation file and application, then it is copied from the extended computing unit memory to the handheld computing unit memory. If there is not sufficient memory in the handheld computing unit, the user may transfer an application and/or file from the handheld computing unit memory to the extended computing unit memory to make room for the presentation file and application.

With the handheld computing unit 12 including the primary components for the computing device 10, there is only one copy of an application and/or of a file to support PC functionality, laptop functionality, and a plurality of handheld device functionality (e.g., TV, digital audio/video player, cell phone, PDA, GPS receiver, etc.). In addition, since only one copy of an application and/or of a file exists (other than desired backups), special software to transfer the applications and/or files from a PC to a handheld device is no longer needed. As such, the processing module, main memory, and I/O interfaces of the handheld computing unit 12 provide a single core architecture for a PC and/or a laptop, a cellular telephone, a PDA, a GPS receiver, a personal digital audio player, a personal digital video player, etc.

FIG. 2 is a schematic block diagram of an embodiment of a computing device 10 that includes a handheld computing unit 12 coupled to an extended computing unit 14 via a docking interface 15. The extended computing unit 14 is coupled to one or more of a monitor 18, a keyboard 20, a mouse 22, a printer 24, and a voice over internet protocol (VoIP) phone 26 via one or more conventional interconnections. The extended computing unit 14 includes a network card 28 that is coupled to a modem 32 (e.g., DSL or cable) directly or via a router 30. The modem 32 is coupled to the internet 34, which is coupled to a general cellular network 36 (e.g., public switched telephone network, mobile core network for GSM, WCDMA, EDGE, UMTS, LTE, etc.).

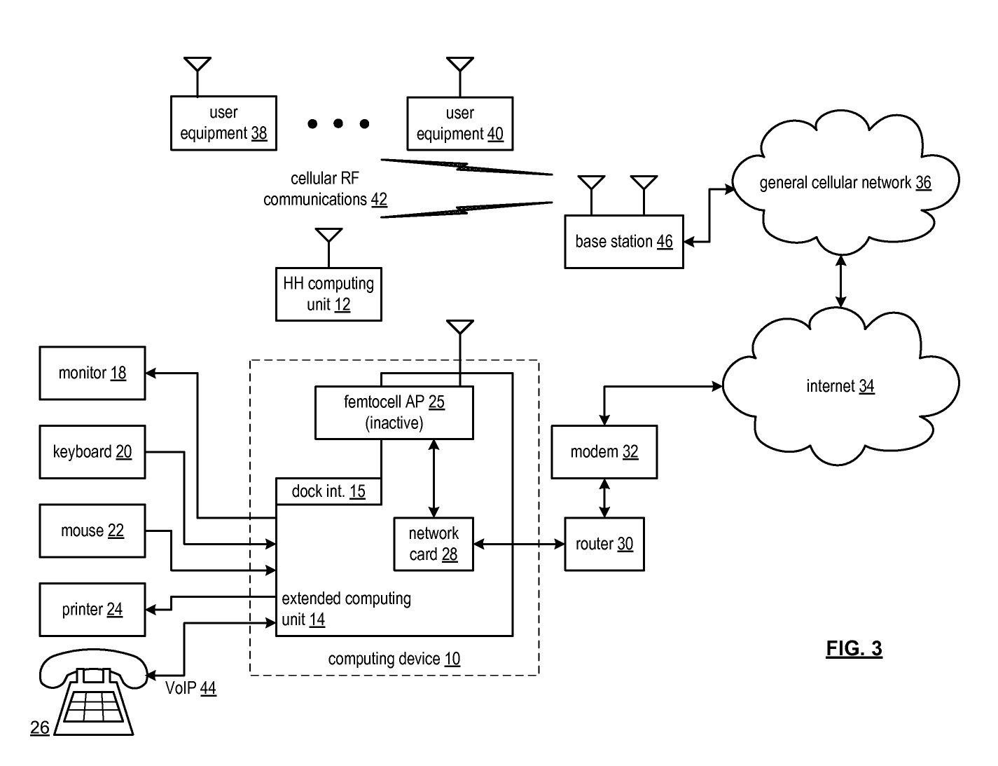

The handheld (HH) computing unit 12 and the extended (EXT) computing unit 14 collectively function as a femtocell access point (AP) 25 to support two or more user equipment 38-40 (e.g., a cellular telephone, push to talk radio, etc.). In this instance, the femtocell AP 25 communicates with the general cellular network 36 via the network card 28, the modem 32, and the internet 34. The femtocell AP 25 functions in accordance with the 3GPP (third generation partnership project) TR 25.xxx specifications for 3G (third generation) systems (e.g., WCDMA) and/or 3GPP TR 45.xxx specifications for GSM systems (e.g., GSM, EDGE, etc.) to support cellular communications of the user equipment 38-50. Details of the HH computing unit 12, the EXT computing unit 14, and the femtocell AP 25 will be provided with reference to FIGS. 3-15.

FIG. 3 is a schematic block diagram of an embodiment of a computing device 10 where the handheld computing unit 12 is not coupled to the extended computing unit 14. In this instance, the femtocell AP 25 is inactive and the HH computing unit 12 functions in a stand-alone mode as disclosed in the above referenced parent patent application. Accordingly, if the HH computing unit 12 desires to participate in a cellular communication, it registers and communicates with a base station 46. Similarly, user equipment 38-40 registers and communicates with base station 46 to participate in cellular communications.

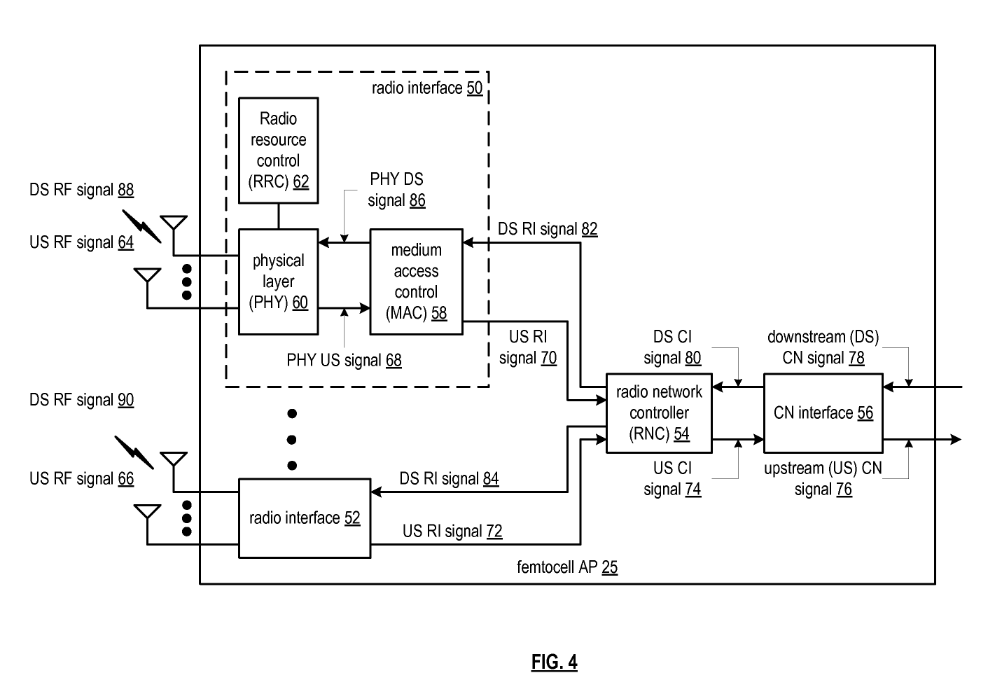

FIG. 4 is a schematic block diagram of an embodiment of a femtocell access point (AP) 25 that includes a plurality of radio interfaces 50-52, a local radio network controller (RNC) 54, and a core network (CN) interface 56. Each of the radio interfaces 50-52 includes a medium access control (MAC) device 58, a physical layer (PHY) device 60, and a radio resource controller (RRC) 62.

In an example of operation, the CN interface 56 receives a downstream (DS) core network (CN) signal 76 from an upstream network component. For example, the upstream network component may be the core network (CN). The DS CN signal 76 is formatted in accordance with an internet protocol (IP) transmission scheme (e.g., TCP/IP, etc.). The content of the DS CN signal 76 includes user data and/or system data that is formatted in accordance with a particular cellular telephone interface protocol (e.g., 3GPP TS 25.410 UTRAN Iu Interface: General Aspects and Principles and other specifications referenced therein). The user data may be cellular network packets, or frames, of voice, text, data, video, audio, etc. data. The system data may include data for registering user equipment, resource allocation, resource management, etc. in accordance with one or more femtocell protocols (e.g., 3GPP TS 25.401 UTRAN overall description and specifications reference therein).

The CN interface 56 converts the DS CN signal 78 in a downstream (DS) CN interface (CI) signal 80. For example, the CN interface 56 recovers the content of the DS CN signal 78 by removing the IP transmission scheme overhead information. The CN interface provides the recovered CS CI signal 80 to the radio network controller (RNC) 54. Note that, in an embodiment, the CN interface 56 and the RNC 54 may collectively function as a HNB (Home Node B gateway).

The RNC 54 converts the DS CI signal 80 into one or more downstream (DS) radio interface (RI) signals 82-84. For instance, if the DS CI signal 80 includes user data and/or system data for more than one radio interface 50-52, then the RNC 54 partitions the signal for the respective radio interfaces 50-52. In general, the RNC 54 functions to perform at least a portion of radio resource management, mobility management, and encryption/decryption of data to/from the user equipment 38-40. Radio resource management includes one or more of outer loop power control, load control, admission control, packet scheduling, handover control, macro-diversity combining, securing functions, and mobility management for user equipment within the femtocell APs coverage area.

The MAC unit 58 receives the DS RI signal 82 and converts it into a physical layer (PHY) downstream (DS) signal 86. This may be done in accordance with one or more femtocell protocols. For example, the MAC unit 58 may convert the DS RI signal 82 into the PHY DS signal 86 in accordance with the 3GPP TS 25.301: Radio Interface Protocol Architecture.

The PHY unit 60 converts the PHY DS signal 86 into a downstream (DS) radio frequency (RF) signal 88 in accordance with one or more femtocell protocols. For example, the PHY unit 60 may convert the PHY DS signal 86 in the DS RF signal 88 in accordance with the 3GPP TS 25.301: Radio Interface Protocol Architecture. In an embodiment, the PHY unit 60 includes a baseband processing module and an RF section.

The radio resource control (RRC) unit 62 provides network layer functionality for the radio interface 50-52. For example, the RRC unit 62 may perform one or more of broadcast information related to non-access stratum, broadcast information related to access stratum, processing of an RRC connection, processing of radio bearers, processing radio resources for the RRC connection, performing RRC connection mobility functions, controlling requested quality of service, power control, processing initial cell selection and cell re-selection, arbitration of the radio resources on an uplink dedicate channel, RRC message integrity protection, cell broadcast service control, and multimedia broadcast multicast service control. Note that processing includes one or more of establishing, maintaining, reconfiguring, and releasing. Further note that functions performed by the RRC unit may be in accordance with one or more femtocell specifications (e.g., 3GPP TS 25.301: Radio Interface Protocol Architecture).

The PHY unit 60 also converts an upstream (US) RF signal 64 into a PHY US signal 68 in accordance with one or more femtocell protocols. The MAC unit 58 converts the PHY US signal 68 into a US RI signal 70 in accordance with one or more femtocell protocols (e.g., 3GPP TS 25.301: Radio Interface Protocol Architecture). Note that radio interface 52 converts a DS RI signal 84 into a DS RF signal 90 and converts a US RF signal 66 into a US RI signal 72 in a similar fashion as discussed with reference to radio interface 50.

The radio network controller (RNC) 54 converts the US RI signals 70-72 into a US CI signal 74 in accordance with one or more femtocell protocols (e.g., 3GPP TS 25.401 UTRAN overall description and specifications reference therein). The CN interface 56 converts the US CI signal 74 into a US CN signal 76. For example, the CN interface 56 formats the US CI signal 74 in accordance with an IP transmission scheme to produce the US CN signal 76. Note that the US CI signal 74 is formatted in accordance with a femtocell protocol (e.g., e.g., 3GPP TS 25.410 UTRAN Iu Interface: General Aspects and Principles and other specifications referenced therein).

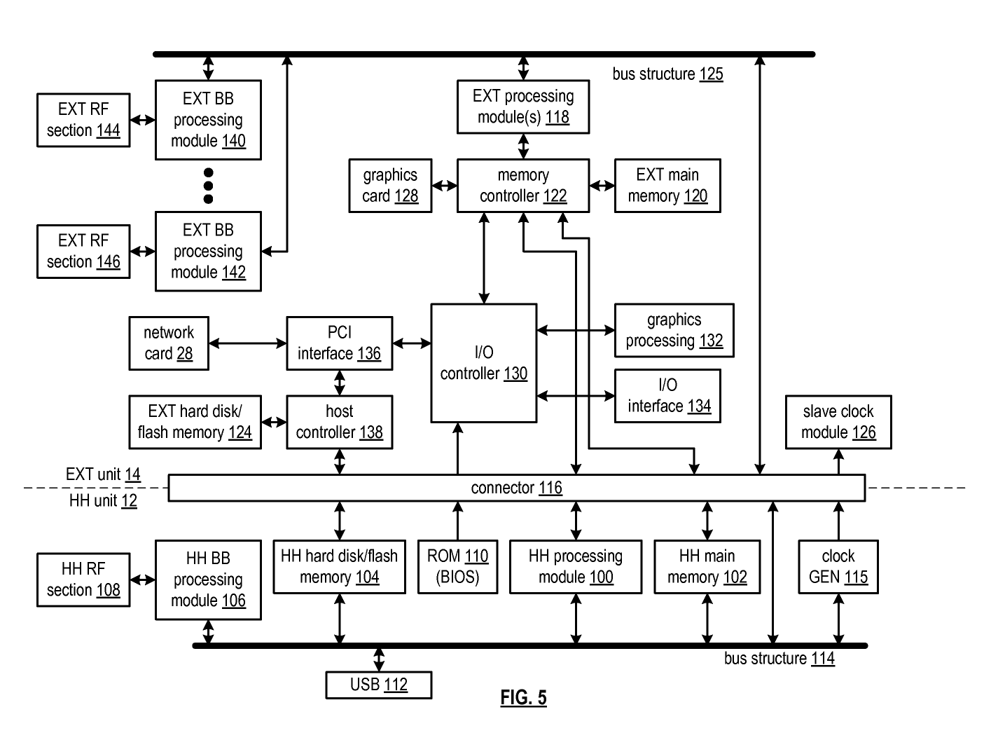

FIG. 5 is a schematic block diagram of an embodiment of core components of a handheld computing unit 12 coupled via connector 116 to an extended computing unit 14. The handheld (HH) computing unit 12 includes an HH processing module 100, an HH main memory 102, an HH hard disk/flash memory 104, a baseband processing module 106, an RF section 108, a ROM 110, a universal serial bus (USB) interface 112, a bus structure 114, and a clock generation circuit 115. The extended (EXT) computing unit 14 includes one or more EXT processing modules 118, an EXT main memory 120, a slave clock module 126, a memory controller 122, a graphics card 128 and/or a graphics processing unit 132, an I/O controller 130, an I/O interface 134, a peripheral component interconnect (PCI) interface 136, a host controller 138, an EXT hard disk/flash memory 124, the network card 28, a bus structure 125, a plurality of EXT baseband (BB) processing modules 140-142, and a plurality of RF sections 144-146.

The connector 116 provides the docking interface 15 between the HH and EXT computing units 12 and 14 and may include one or more wired connectors, one or more wireless interfaces, and/or one or more magnetic coupling interfaces. A wired connector may be a plug and socket connector, etc. A wireless interface may be supported by radio frequency (RF) and/or millimeter wave (MMW) transceivers that support one or more types of wireless communication protocols (e.g., Bluetooth, ZigBee, 802.11, 60 GHz, etc.). A magnetic coupling interface may be supported by transceivers with magnetic coils.

The bus structures 114 and 125 may each be wired and/or wireless buses. A wired bus may include 8 or more lines for data, for instructions, for control. A wireless bus may be implemented as an RF bus as described in co-pending patent application RF BUS CONTROLLER, having a filing date of Jan. 31, 2007, and a Ser. No. 11/700,285.

With handheld computing unit 12 docked to the extended computing unit 14, their components function as a single computing device 10. As such, when the computing device 10 is enabled, the BIOS stored on the HH ROM 110 is executed to boot up the computing device. The BIOS is discussed in greater detail with reference to FIGS. 19-26 of the parent patent application. After initializing the operating system, which is described in greater detail with reference to FIGS. 19-22 and 27-36 of the parent patent application, the computing device 10 is ready to execute a user application.

In an embodiment, the memory controller 122 coordinates the reading data from and writing data to the HH main memory 102 and the EXT main memory 120, by the processing modules 100 and 118, by the user I/O devices coupled directly or indirectly to the I/O controller 130, by the graphics card 128, and/or for data transfers with the HH and/or EXT hard disk/flash memory 104 and/or 124. Note that if the HH main memory 102 and/or the EXT main memory include DRAM, the memory controller 122 includes logic circuitry to refresh the DRAM.

The I/O controller 130 provides access to the memory controller 122 for typically slower devices. For example, the I/O controller 130 provides functionality for the PCI bus via the PCI interface 136; for the I/O interface 134, which may provide the interface for the keyboard, mouse, printer, and/or a removable CD/DVD disk drive; and BIOS interface; a direct memory access (DMA) controller, interrupt controllers, a host controller, which allows direct attached of the EXT hard disk memory; a real time clock, an audio interface. The I/O controller 130 may also include support for an Ethernet network card, a Redundant Arrays of Inexpensive Disks (RAID), a USB interface, and/or FireWire.

The graphics processing unit (GPU) 132 is a dedicated graphics rendering device for manipulating and displaying computer graphics. In general, the GPU implements a number of graphics primitive operations and computations for rendering two-dimensional and/or three-dimensional computer graphics. Such computations may include texture mapping, rendering polygons, translating vertices, programmable shaders, aliasing, and very high-precision color spaces. The GPU 132 may a separate module on a video card or it may be incorporated into the graphics card 128 that couples to the memory controller 122. Note that a video card, or graphics accelerator, functions to generate the output images for the EXT display. In addition, the video card may further include functionality to support video capture, TV tuner adapter, MPEG-2 and MPEG-4 decoding or FireWire, mouse, light pen, joystick connectors, and/or connection to two monitors.

The EXT baseband processing modules 140-142 and the RF sections 144-146 are operable when the HH computing unit is docked to the EXT computing unit. Each of the RF sections 144-146 includes a receiver section and a transmitter section. When operable, each combination of the EXT baseband processing modules 140-142 and the RF sections 144-146 provides at least a portion of a radio interface 50 of the femtocell AP 25. For example, EXT BB processing module 140 and EXT RF section 144 may provide the radio interface to user equipment 38.

The EXT processing module 118, the memory controller 122, the EXT main memory 120, the I/O controller 130, the I/O interface 134, the PCI interface 136, the host controller 138, the EXT baseband processing modules 140-142, and the EXT RF sections 144-146 may be implemented on a single integrated circuit, each on separate integrated circuits, or some elements may be implemented on the same integrated circuits. For example, the EXT processing module 118, at least one of the EXT baseband processing modules 140-142, and the memory controller 122 may be implemented on the same integrated circuit.

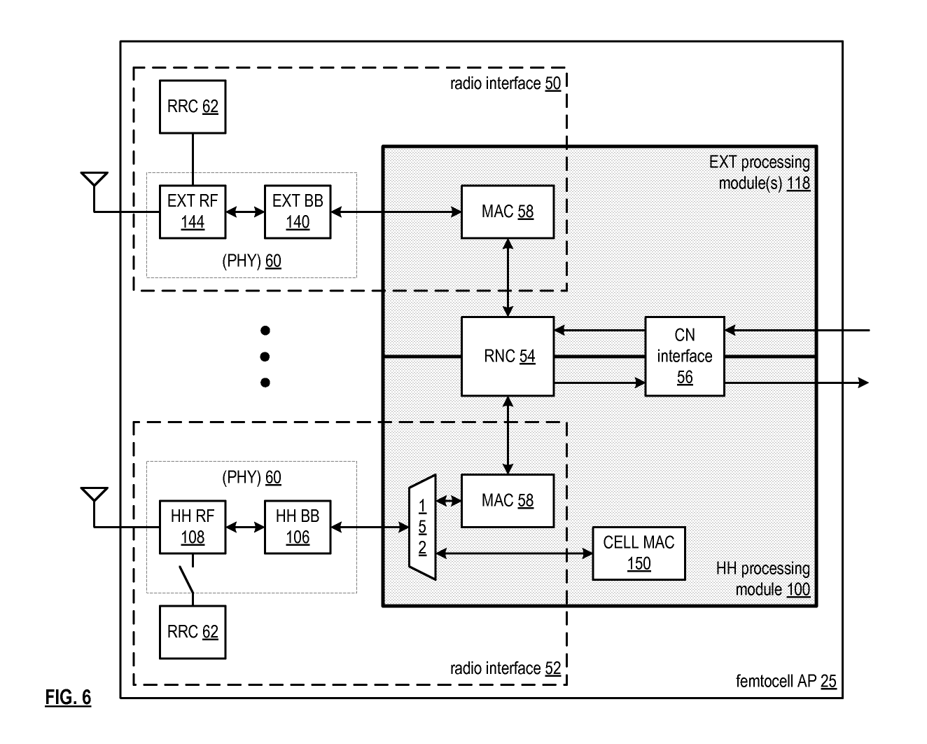

FIG. 6 is a schematic block diagram of an embodiment of a handheld (HH) computing unit 12 and an extended (EXT) computing unit 14 implementing a femtocell AP 25. The HH computing unit components include the HH processing module 100, the HH baseband processing module 106, and the HH RF section 108. The EXT computing unit components include the EXT processing module 118, the EXT baseband processing modules 140-142, and the EXT RF sections 144-146.

In this embodiment, a combination of the HH processing module 100 and the EXT processing module(s) 118 implements the core network (CN) interface 56 function and the local radio network controller (RNC) 54 function. In addition, the HH processing module 100 implements a cellular (CELL) MAC unit 150 and the MAC unit 58 for radio interface 52 and the EXT processing module(s) 118 implement the MAC unit 58 for the other radio interfaces 50. Further, the HH baseband processing module 100 and/or the HH processing module(s) 106 implements the radio resource control (RRC) unit 62 for the radio interfaces 52 and the EXT baseband processing module 140 and/or the EXT processing module(s) 118 implement the radio resource control (RRC) unit 62 of the other radio interfaces 50.

In an example of the HH and EXT computing units 12 and 14 implementing the femtocell AP 25, the femtocell AP 25 registers with the core network and registers the user equipment 38-40 in accordance with one or more femtocell protocols (e.g., 3GPP TS 25.467: UTRAN architecture for 3G Home Node B). After the registration processes, femtocell AP is ready to transceive user data and/or system data with the user equipment. For user and/or system data from the user equipment, the receiver section of EXT RF section 144 receives an upstream RF signal (e.g., signal 64 of FIG. 4) and amplifies it to produce an amplified upstream RF signal. The receiver section may then mix in-phase (I) and quadrature (Q) components of the amplified upstream RF signal with in-phase and quadrature components of a local oscillation to produce a mixed I signal and a mixed Q signal. The mixed I and Q signals are combined to produce an upstream symbol stream. In this embodiment, the upstream symbol may include phase information (e.g., +/−Δθ [phase shift] and/or θ(t) [phase modulation]) and/or frequency information (e.g., +/−Δf [frequency shift] and/or f(t) [frequency modulation]). In another embodiment and/or in furtherance of the preceding embodiment, the upstream RF signal includes amplitude information (e.g., +/−ΔA [amplitude shift] and/or A(t) [amplitude modulation]). To recover the amplitude information, the receiver section includes an amplitude detector such as an envelope detector, a low pass filter, etc.

The EXT baseband processing module 140 converts the upstream symbol stream into the PHY upstream signal (e.g., signal 68 of FIG. 4) in accordance with one or more cellular communication standards (e.g., GSM, CDMA, WCDMA, HSUPA, HSDPA, EDGE, GPRS, LTE, UMTS, EV-DO, etc.). Such a conversion may include one or more of: digital intermediate frequency to baseband conversion, time to frequency domain conversion, space-time-block decoding, space-frequency-block decoding, demodulation, frequency spread decoding, frequency hopping decoding, beamforming decoding, constellation demapping, deinterleaving, decoding, depuncturing, and/or descrambling.

In addition, the EXT baseband processing module 140, alone, in combination with the EXT RF section 144, and/or in combination with the EXT processing module(s) 118 facilitates one or more of macro-diversity distribution and combining; soft handover execution; error detection on transport channels; forward error correction encoding and decoding of the transport channels; multiplexing of the transport channels; demultiplexing of coded composite transport channels; rate matching of the coded transport channels to physical channels; mapping of the coded composite transport channels on the physical channels; power weighting and combining of the physical channels; modulation and spreading demodulation of the physical channels; de-spreading of the physical channels; frequency and time synchronization; beamforming; and Multiple Input Multiple Output (MIMO) transmission. Such additional functional processing is in accordance with one or more femtocell protocols (e.g., 3GPP TS 25.301: Radio Interface Protocol Architecture).

The EXT processing module(s) 118 implement the MAC unit 58, which converts the PHY upstream signal into an upstream radio interface (RI) signal (e.g., signal 70 of FIG. 4) in accordance with one or more femtocell protocols (e.g., 3GPP TS 25.301: Radio Interface Protocol Architecture). The MAC unit 58 provides the upstream RI signal to the RNC 54.

While the EXT RF sections 144-146 and the EXT baseband processing modules 140-142 are converting upstream RF signals into upstream PHY signals, the HH RF section 108 and the HH baseband processing module 106 are performing a similar function for another user equipment. The HH baseband processing module 106 provides the upstream PHY signal to the MAC unit 58 via a multiplexer 152. The multiplexer 152 may be a logical multiplexer, a physical multiplexer, or a switching circuit that, when the computing unit is in the femtocell mode, the multiplexer 152 provides connectivity between the MAC unit 58 and the HH baseband processing module 106. When the computing unit is in the cellular mode, the multiplexer 152 provides connectivity between the CELL MAC unit 150 and the HH baseband processing module 106.

The MAC unit 58, which is being implemented by the HH processing module 100, processes the upstream PHY signal to produce an upstream RI signal. The MAC unit 58 provides the upstream RI signal to the RNC 54.

The EXT and/or the HH processing modules 100 and/or 118 implement the RNC 54, which converts the upstream (US) RI signals (e.g., signals 70-72 of FIG. 4) into a US core network interface (CI) signal (e.g., signal 74 of FIG. 4) in accordance with one or more femtocell protocols (e.g., 3GPP TS 25.401 UTRAN overall description and specifications reference therein).

The EXT and/or the HH processing modules 100 and/or 118 also implement the CN interface 56, which converts the US CI signal into a US core network (CN) signal (e.g., signal 76 of FIG. 4). For example, the CN interface 56 formats the US CI signal 74 in accordance with an IP transmission scheme to produce the US CN signal 76. Note that the US CI signal is formatted in accordance with a femtocell protocol (e.g., e.g., 3GPP TS 25.410 UTRAN Iu Interface: General Aspects and Principles and other specifications referenced therein).

The CN interface 56 provides the upstream CN signal to the core network (e.g., the general cellular network 36) via the internet 34. Accordingly, the CN interface 56 (as implemented by the HH and/or EXT processing modules) provides the upstream CN signal to the memory controller, which forwards the upstream CN signal to the network card directly or via the IO controller and the PCI interface.

For user and/or system data for the user equipment, the CN interface receives a downstream (DS) core network (CN) signal (e.g., signal 78 of FIG. 4) from the internet via the network card, the memory controller, and any other intervening components. The CN interface 56 converts the DS CN signal in a downstream (DS) CN interface (CI) signal (e.g., signal 80 of FIG. 4). For example, the CN interface 56 recovers the content of the DS CN signal 78 by removing the IP transmission scheme overhead information. The CN interface provides the recovered CS CI signal to the radio network controller (RNC) 54.

The RNC 54 converts the DS CI signal 80 into one or more downstream (DS) radio interface (RI) signals (e.g., signals 82-84 of FIG. 4). For instance, if the DS CI signal includes user data and/or system data for more than one user equipment and, hence more than one radio interface 50-52, the RNC 54 partitions the signal for the respective radio interfaces 50-52.

For DS RI signals for radio interface 50, the MAC unit 58 implemented by the EXT processing module(s) 118 converts the DS RI signal into a physical layer (PHY) downstream (DS) signal (e.g., signal 86 of FIG. 4). This may be done in accordance with one or more femtocell protocols. For example, the MAC unit 58 may convert the DS RI signal 82 into the PHY DS signal 86 in accordance with the 3GPP TS 25.301: Radio Interface Protocol Architecture.

The EXT baseband processing module 140 converts the DS PHY signal into a downstream symbol stream in accordance with one or more wireless communication standards (e.g., GSM, CDMA, WCDMA, HSUPA, HSDPA, EDGE, GPRS, LTE, UMTS, EV-DO, etc.). Such a conversion includes one or more of: scrambling, puncturing, encoding, interleaving, constellation mapping, modulation, frequency spreading, frequency hopping, beamforming, space-time-block encoding, space-frequency-block encoding, frequency to time domain conversion, and/or digital baseband to intermediate frequency conversion.

The transmitter section of EXT RF section 144 converts the downstream symbol stream into a downstream RF signal that has a carrier frequency within a given frequency band (e.g., 900 MHz, 1800-2200 MHz, etc.). In an embodiment, this may be done by mixing the downstream symbol stream with a local oscillation to produce an up-converted signal. One or more power amplifiers and/or power amplifier drivers amplifies the up-converted signal, which may be RF bandpass filtered, to produce the downstream RF signal. In another embodiment, the transmitter section includes an oscillator that produces an oscillation. The downstream symbol stream provides phase information (e.g., +/−Δθ[phase shift] and/or θ(t) [phase modulation]) that adjusts the phase of the oscillation to produce a phase adjusted RF signal, which is transmitted as the downstream RF signal. In another embodiment, the downstream symbol stream includes amplitude information (e.g., A(t) [amplitude modulation]), which is used to adjust the amplitude of the phase adjusted RF signal to produce the downstream RF signal.

In yet another embodiment, the transmitter section includes an oscillator that produces an oscillation. The downstream symbol provides frequency information (e.g., +/−Δf [frequency shift] and/or f(t) [frequency modulation]) that adjusts the frequency of the oscillation to produce a frequency adjusted RF signal, which is transmitted as the downstream RF signal. In another embodiment, the downstream symbol stream includes amplitude information, which is used to adjust the amplitude of the frequency adjusted RF signal to produce the downstream RF signal. In a further embodiment, the transmitter section includes an oscillator that produces an oscillation. The downstream symbol provides amplitude information (e.g., +/−ΔA [amplitude shift] and/or A(t) [amplitude modulation) that adjusts the amplitude of the oscillation to produce the downstream RF signal.

The MAC unit 58 implemented by the HH processing module 100 converts the DS RI signal for the user equipment supported by radio interface 52 into a physical layer (PHY) downstream (DS) signal. The HH baseband processing module 106 converts the PHY DS signal into a downstream symbol stream, which is converted into a downstream RF signal by the HH RF section 108.

When the computing unit is in the cellular mode, the CN interface 56, the RNC 54, and the MAC units 58 implemented by the EXT processing module are disabled. Alternatively, these components may be active, where the EXT processing module 118 performs the CN interface 56 and the RNC 54 without contribution from the HH processing module 100. In the latter instance, the EXT computing unit 14 functions as the femtocell AP without the radio interface implemented by the components of the HH computing unit 12.

In the cellular mode, the components of the HH computing unit 12 function as a cellular telephone. In this mode, the CELL MAC unit 150 is active to provide one or more of the upper layer functions (e.g., data link, network, transport, session, presentation, and application) for upstream and/or downstream data (e.g., voice, text, audio, video, graphics, etc.). For instance, the CELL MAC unit 150 converts downstream data into a downstream cellular (CELL) PHY signal. The HH baseband processing module 106 converts the downstream CELL PHY signal into a downstream CELL symbol stream. The HH RF section 108 converts the downstream CELL symbol stream into a downstream CELL RF signal.

The HH RF section 108 also converts an upstream (US) CELL RF signal into an US CELL symbol stream. The HH baseband processing module 106 converts the UP CELL symbol stream into an US CELL PHY signal. The CELL MAC unit 150 converts the US CELL PHY signal into upstream data that is provided to memory for storage and/or to the IO devices for presentation (e.g., rendered audible and/or visible).

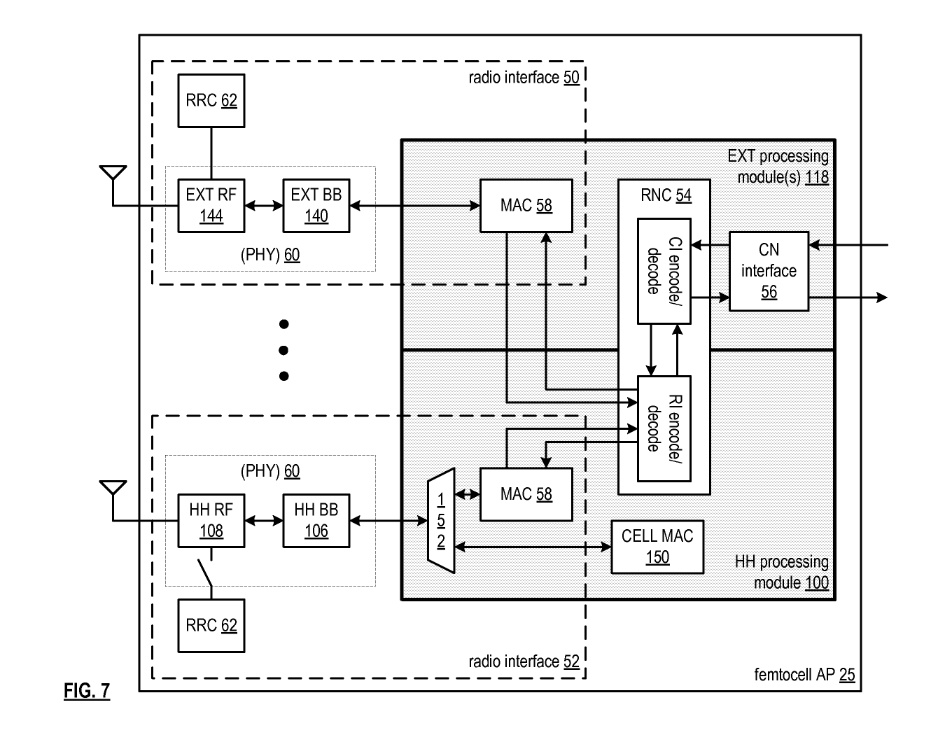

FIG. 7 is a schematic block diagram of another embodiment of a handheld (HH) computing unit 12 and an extended (EXT) computing unit 14 implementing a femtocell AP 25. The HH computing unit components include the HH processing module 100, the HH baseband processing module 106, and the HH RF section 108. The EXT computing unit components include the EXT processing module 118, the EXT baseband processing modules 140-142, and the EXT RF sections 144-146.

In this embodiment, the EXT processing module(s) 118 implements the CN interface and a combination of the HH processing module 100 and the EXT processing module(s) 118 implements the local radio network controller (RNC) 54. In particular, the EXT processing module(s) 118 implement a core network interface (CI) encoding/decoding function and the HH processing module 100 implements a radio interface (RI) encoding/decoding function. In general, the CI encoding/decoding function corresponds to formatting signals for the Iu interface with the core network, which may be done in accordance with one or more femtocell protocols (e.g., 3GPP TS 25.410: UTRAN Iu interface: General Aspects and Principles and other specifications referenced therein). The RI encoding/decoding corresponds to formatting signals for the Uu interface with the user equipment, which may be done in accordance with one or more femtocell protocols (e.g., 3GPP TS 25.301: Radio Interface Protocol Architectures and other specifications referenced therein).

In an example of operation, the RNC 54 receives a downstream (DS) core network interface (CI) signal from the CN interface 56. The CI encoding/decoding unit decodes the DS CI signal in accordance with the femtocell protocol to produce a decoded DS CI data signal. The EXT and/or the HH processing modules 100 and/or 118 perform one or more RNC functions upon the decoded DS CI data signal to produce a processed DS CI data signal. Such RNC functions include radio resource management, mobility management, and encryption/decryption of data to/from the user equipment 38-40. Radio resource management includes one or more of outer loop power control, load control, admission control, packet scheduling, handover control, macro-diversity combining, securing functions, and mobility management for user equipment within the femtocell APs coverage area.

The RI encoding/decoding unit (implemented by the HH processing module 100) encodes the processed DS CI data signal in accordance with one or more femtocell protocols to produce the DS radio interface (RI) signals (e.g., signals 82-84 of FIG. 4). The RI encoding/decoding unit also decodes upstream (US) RI signals in accordance with the one or more femtocell protocols to produce decoded US RI signals.

The EXT and/or the HH processing modules 100 and/or 118 perform one or more RNC functions upon the decoded US RI signals to produce processed US RI signals. The CI encoding/decoding unit (implemented by the EXT processing module 118) encodes the processed US RI signals to produce the US CI signal (e.g., signal 74 of FIG. 4).

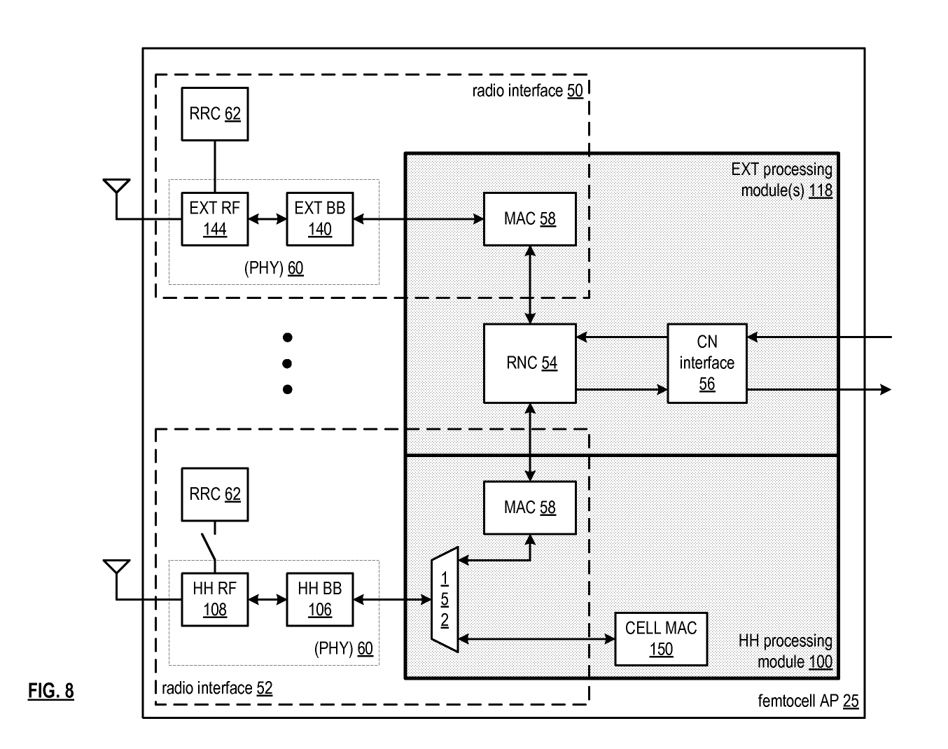

FIG. 8 is a schematic block diagram of another embodiment of a handheld (HH) computing unit 12 and an extended (EXT) computing unit 14 implementing a femtocell AP 25. The HH computing unit components include the HH processing module 100, the HH baseband processing module 106, and the HH RF section 108. The EXT computing unit components include the EXT processing module 118, the EXT baseband processing modules 140-142, and the EXT RF sections 144-146.

In this embodiment, the EXT processing module(s) 118 implements the CN interface 56, the RNC 54, and the MAC units 58 for the radio interfaces 50. The HH processing module 100 implements the MAC unit 58 for the radio interfaces 52. For example, the EXT processing module operably coupled to perform the core network interface function and the local radio control network function. In addition, the EXT processing module 118 performs the MAC function to facilitate conversion of a first one of the plurality of downstream RI signals into a first one of the plurality of downstream PHY AP signals and a first one of the plurality of upstream PHY AP signals into a first one of the plurality of upstream RI signals. For instance, the first US PHY AP signal may be signal 68 of FIG. 4 and the first DS PHY AP signal may be signal 86 of FIG. 4.

In this example, the HH processing module performs the MAC function to facilitate conversion of a second one of the plurality of downstream RI signals into a second one of the plurality of downstream PHY AP signals and a second one of the plurality of upstream PHY AP signals into a second one of the plurality of upstream RI signals. For instance, the second US PHY AP signal may be the signal provided by the HH baseband processing module 106 to the MAC unit 58 (implemented by the HH processing module 100) and the DS PHY AP signal may be the signal provided by the MAC unit 50 to the HH baseband processing module 106.

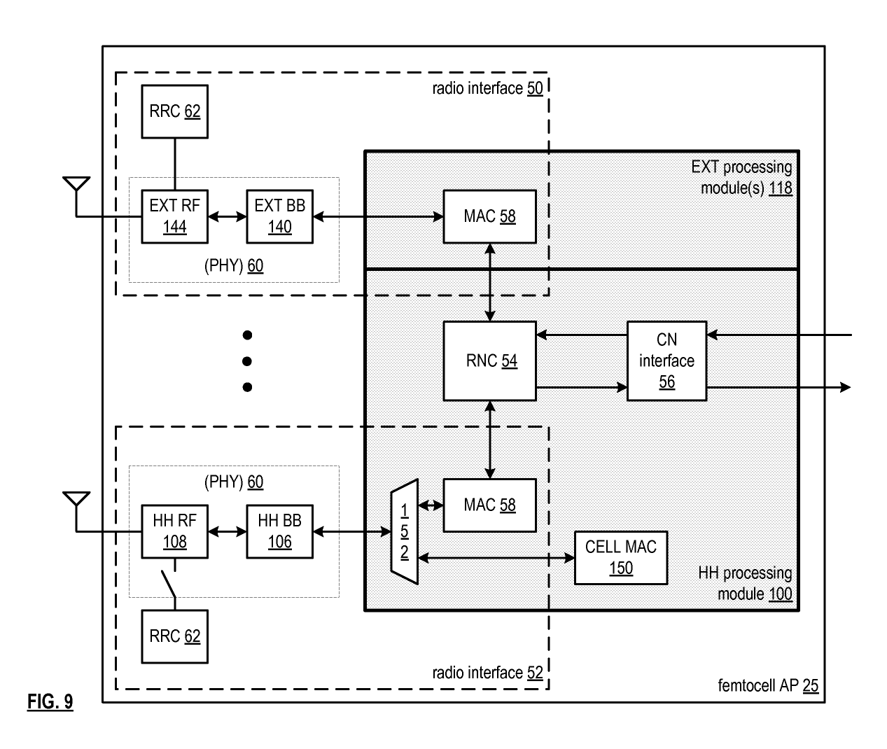

FIG. 9 is a schematic block diagram of another embodiment of a handheld (HH) computing unit 12 and an extended (EXT) computing unit 14 implementing a femtocell AP 25. The HH computing unit components include the HH processing module 100, the HH baseband processing module 106, and the HH RF section 108. The EXT computing unit components include the EXT processing module 118, the EXT baseband processing modules 140-142, and the EXT RF sections 144-146.

In this embodiment, the EXT processing module(s) 118 implements the MAC units 58 for the radio interfaces 50. The HH processing module 100 implements the CN interface 56, the RNC 54, and the MAC unit 58 for the radio interfaces 52.

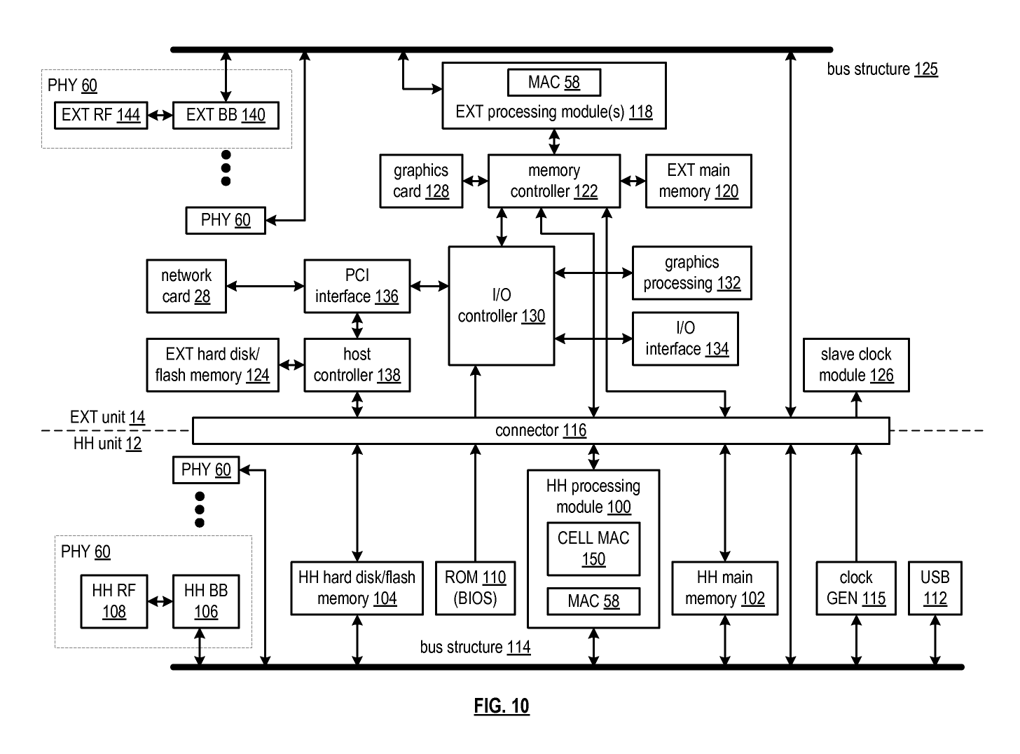

FIG. 10 is a schematic block diagram of another embodiment of core components of a handheld computing unit 12 coupled via connector 116 to an extended computing unit 14. The handheld (HH) computing unit 12 includes the HH processing module 100, the HH main memory 102, the HH hard disk/flash memory 104, a plurality of PHY units (e.g., a plurality of baseband processing modules 106 and a plurality of RF sections 108), the ROM 110, the universal serial bus (USB) interface 112, the bus structure 114, and the clock generation circuit 115. The extended (EXT) computing unit 14 includes the one or more EXT processing modules 118, the EXT main memory 120, the slave clock module 126, the memory controller 122, the graphics card 128 and/or the graphics processing unit 132, the I/O controller 130, the I/O interface 134, the peripheral component interconnect (PCI) interface 136, the host controller 138, the EXT hard disk/flash memory 124, the network card 28, the bus structure 125, and a plurality of PHY units 60 (e.g., the plurality of EXT baseband (BB) processing modules 140-142 and the plurality of RF sections 144-146).

In this embodiment, the EXT baseband processing modules 140-142 and the RF sections 144-146 are operable when the HH computing unit is docked to the EXT computing unit. Alternatively, when the HH computing unit is not docked, the EXT computing unit 14 may function as the femtocell AP using its baseband processing modules and RF sections. When operable, each combination of the EXT baseband processing modules 140-142 and the RF sections 144-146 provides at least a portion of a radio interface 50 of the femtocell AP 25. In addition, the EXT processing module 118 provides the MAC unit 58 for the radio interface 50.

Each combination of HH baseband processing modules 106 and HH RF sections 108 provides at least a portion of a radio interface 52 of the femtocell AP 25 when the HH unit is in the femtocell mode (e.g., docked to the EXT unit). In addition, the HH processing module 100 provides the MAC unit 58 for the radio interface 52. When the HH unit is in the cellular mode (e.g., not docked to the EXT unit), each combination of HH baseband processing modules 106 and HH RF sections 108 provides a separate RF transceiver, which may be used independently to provide multi-mode service. In this mode, the HH processing module 100 provides the CELL MAC unit 150.

FIG. 11 is a schematic block diagram of another embodiment of core components of a handheld computing unit 12 coupled via connector 116 to an extended computing unit 14. The handheld (HH) computing unit 12 includes the HH processing module 100, the HH main memory 102, the HH hard disk/flash memory 104, a plurality of PHY units (e.g., a plurality of baseband processing modules 106 and a plurality of RF sections 108), the ROM 110, the universal serial bus (USB) interface 112, the bus structure 114, the memory controller 122, the I/O controller 130, the peripheral component interconnect (PCI) interface 136, and the clock generation circuit 115. The extended (EXT) computing unit 14 includes the one or more EXT processing modules 118, the EXT main memory 120, the slave clock module 126, the graphics card 128 and/or the graphics processing unit 132, the I/O interface 134, the host controller 138, the EXT hard disk/flash memory 124, the network card 28, the bus structure 125, and a plurality of PHY units 60 (e.g., the plurality of EXT baseband (BB) processing modules 140-142 and the plurality of RF sections 144-146).

In this embodiment, the HH unit 12 and the EXT unit 14 function as previously discussed to provide a femtocell AP 25. When the HH unit 12 is in a cellular mode (e.g., not docked to the EXT unit 14), the EXT unit 14 is disabled and the HH unit 12 provides cellular functions and other functions as discussed in the above referenced parent patent application.

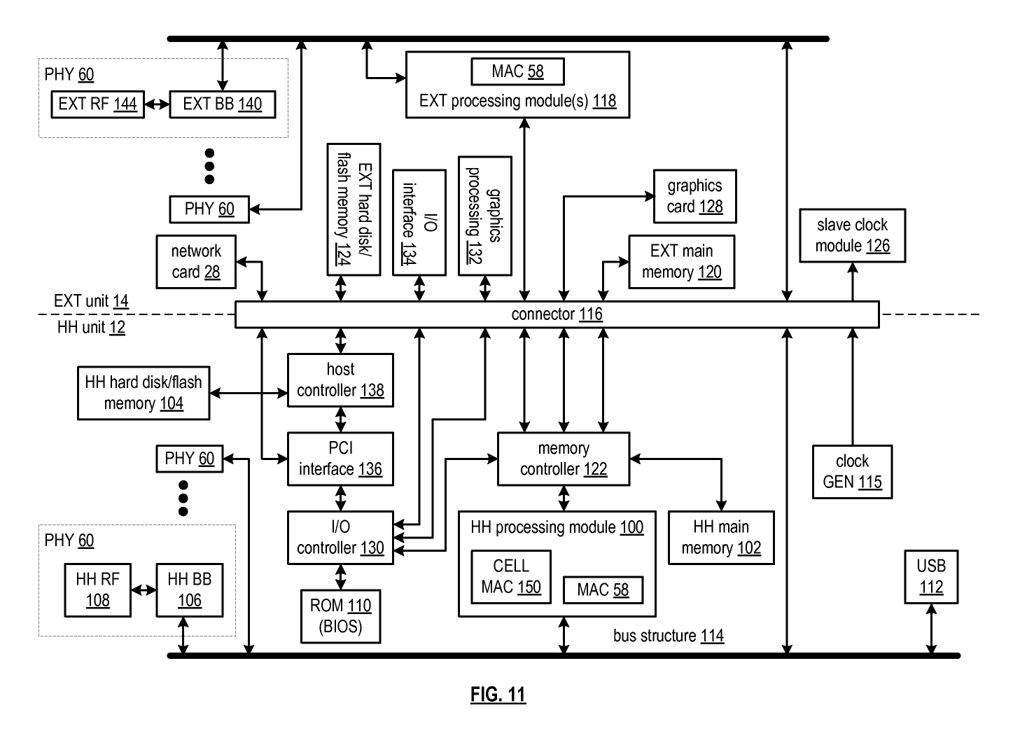

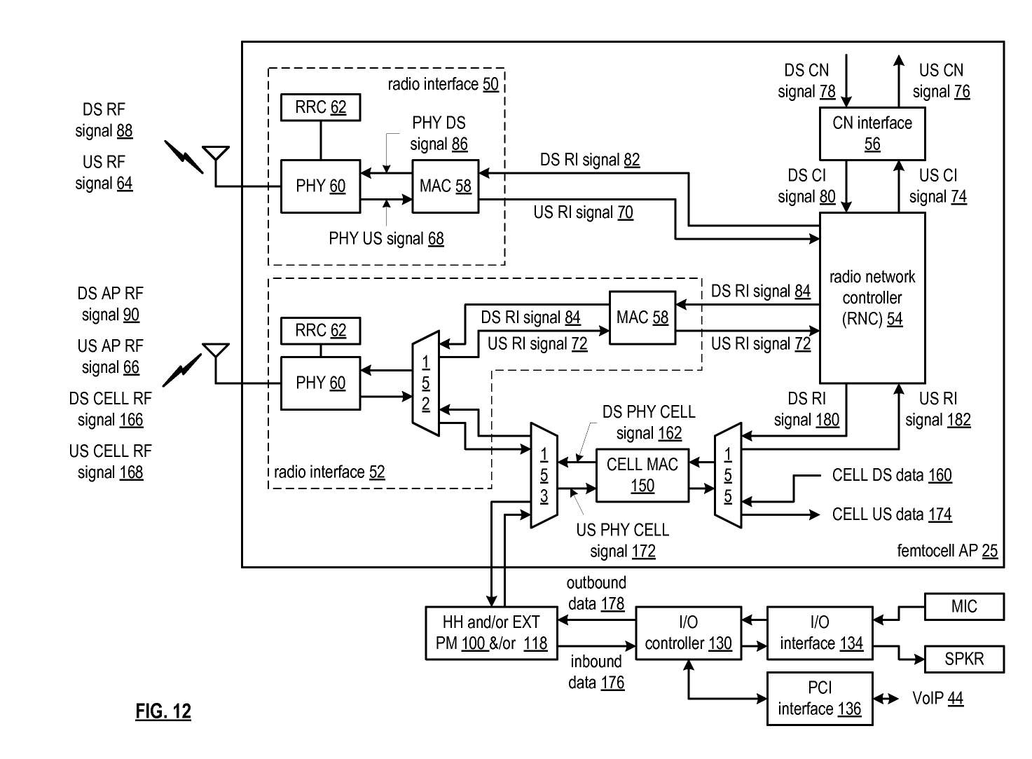

FIG. 12 is a schematic block diagram of another embodiment of a handheld computing unit 12 and an extended computing unit 14 implementing a femtocell AP25. The combination of the HH unit 12 and the EXT unit 14 implements the CN interface 56, the radio network controller (RNC) 54, the radio interfaces 50-52, multiplexers 152, 153, and 155. The radio interfaces 50-52 include the MAC unit 58, the PHY unit 60, and the radio resource controller (RRC) 62.

In an example of operation, the CN interface 56 receives a downstream (DS) core network (CN) signal 76 from an upstream network component. The DS CN signal 76 is formatted in accordance with an internet protocol (IP) transmission scheme (e.g., TCP/IP, etc.). The content of the DS CN signal 76 includes user data and/or system data that is formatted in accordance with a particular cellular telephone interface protocol (e.g., 3GPP TS 25.410 UTRAN Iu Interface: General Aspects and Principles and other specifications referenced therein).

The CN interface 56 converts the DS CN signal 78 in a downstream (DS) CN interface (CI) signal 80. For example, the CN interface 56 recovers the content of the DS CN signal 78 by removing the IP transmission scheme overhead information. The CN interface provides the recovered CS CI signal 80 to the radio network controller (RNC) 54.

The RNC 54 converts the DS CI signal 80 into one or more downstream (DS) radio interface (RI) signals 82-84 and 180. For instance, if the DS CI signal 80 includes user data and/or system data for the HH unit 12 and one or more user equipment 38-40, the RNC 54 partitions the signal for the respective user devices (e.g., HH unit and the user equipment). When the DS RI signals are for the user equipment, the RNC 54 provide them to the respective radio interfaces 50-52. When one of the DS RI signals 180 is for the HH unit 12, the RNC 54 provides the signal 180 to the CELL MAC unit 150 via the multiplexer 155.

In this instance, the one or more PHY units 60 (e.g., HH BB processing modules and HH RF sections) of the HH unit are used by the femtocell AP 25 to support cellular communication with one of the user equipment. For cellular communications with the HH unit 12, the RNC 54 provides the RI signal to the CELL MAC 150 instead of a radio interface 50-52.

The CELL MAC unit 150 processes the DS RI signal 180 as previously discussed to produce a downstream PHY CELL signal 162. Multiplexer 153 provides the downstream PHY CELL signal 162 to the HH and/or EXT processing modules 118, which convert the downstream PHY CELL signal 162 into inbound, or downstream, data 176 (e.g., voice, text, audio, video, graphics, etc.). Such a conversion may include a decompression of compressed data contained in the PHY CELL signal, format conversion (e.g., Pulse Code Modulation to MP3), etc. The IO controller 130 forwards the inbound data 176 to the IO interface 134, which provides the data 176 to a speaker assembly SPKR (e.g., one or more speakers).

For the other DS RI signals 82-84, the corresponding MAC units 58 converts the DS RI signal 82-84 into a physical layer (PHY) downstream (DS) signal 86 in accordance with one or more femtocell protocols. The corresponding PHY units 60 convert the PHY DS signal 86 into a downstream (DS) radio frequency (RF) signal 88-90 in accordance with one or more femtocell protocols. The radio resource control (RRC) unit 62 provides network layer functionality for the radio interface 50-52.

The corresponding PHY units 60 also convert an upstream (US) RF signal 64-66 into a PHY US signal 68 in accordance with one or more femtocell protocols. The corresponding MAC units 58 convert the PHY US signal 68 into a US RI signal 70-72 in accordance with one or more femtocell protocols.

For upstream cellular communications from the HH unit 12, the HH and/or EXT processing modules 100 and/or 118 provide a US PHY CELL signal 172 to the CELL MAC unit 150 via multiplexer 153. The US PHY CELL signal 172 may be user data and/or system data. For user data, the HH and/or EXT processing modules may retrieve it from memory or receive it from the IO controller 130. For user data received from the IO controller 130, the outbound, or upstream, data 178 may be audio data received via a microphone MIC and the IO interface 134.

The CELL MAC unit 150 converts the US PHY CELL signal 172 in an upstream (US) RI signal 182 in accordance with one or more cellular communication protocols (e.g., GSM, CDMA, WCDMA, HSUPA, HSDPA, EDGE, GPRS, LTE, UMTS, EV-DO, etc.). The CELL MAC unit 150 provides the US RI signal 182 to the RNC 54 via multiplexer 155. Note that multiplexers 152, 153, and 155 may each be logical multiplexers, physical multiplexers, and/or switching circuits.

The radio network controller (RNC) 54 converts the US RI signals 70-72 and the US RI signal 182 into a US CI signal 74 in accordance with one or more femtocell protocols (e.g., 3GPP TS 25.401 UTRAN overall description and specifications reference therein). The CN interface 56 converts the US CI signal 74 into a US CN signal 76.

FIG. 13 is a schematic block diagram of an example of a handheld computing unit 12 and an extended computing unit 14 of FIG. 12 in a cellular mode. In this mode, the HH unit 12 is in a stand-alone mode (e.g., is not docked to the EXT unit 14). The light lines indicate inactive components and interconnections therebetween and the darker lines indicate active components and interconnections therebetween. In this example, the CELL MAC unit 150 and the PHY unit 60 (e.g., HH BB processing module and HH RF section) of the HH unit 12 are active.

The CELL MAC unit 150 receives cellular downstream (CELL DS) data 160 from the HH processing module, from an input component (e.g., microphone and corresponding audio processing circuitry), and/or from the HH main memory. The CELL MAC unit 150 converts the CELL DS data 160 into the DS PHY CELL signal 162. The PHY unit 60 converts the DS PHY CELL signal 162 into a DS CELL RF signal 166.

The PHY unit 60 also converts an upstream (US) RF signal 168 into a US PHY CELL signal 172. The CELL MAC unit 150 converts the US PHY CELL signal 172 into CELL US data 174, which is provided to the HH processing module, the HH main memory, and/or to the IO controller of the HH unit.

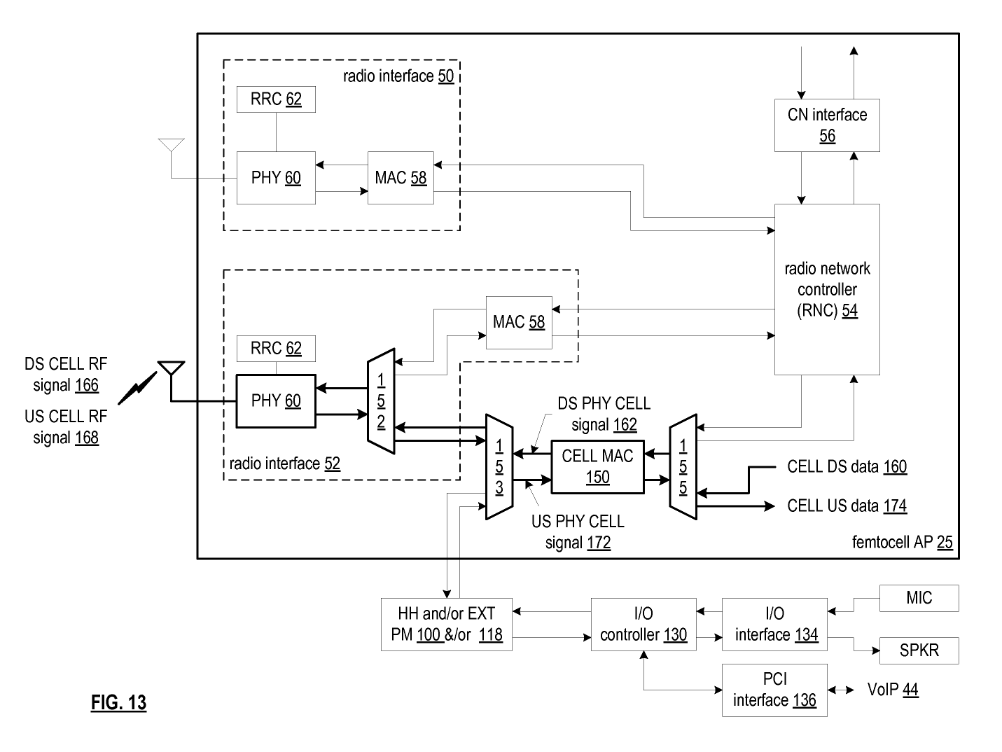

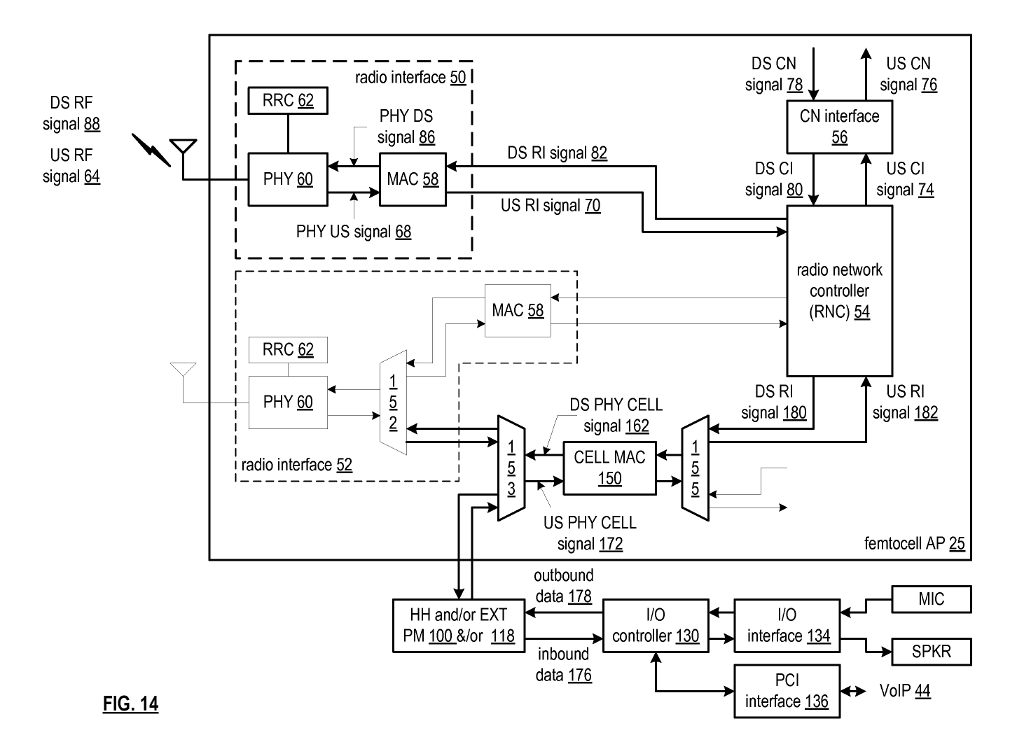

FIG. 14 is a schematic block diagram of an example of a handheld computing unit 12 and an extended computing unit 14 of FIG. 12 in a femtocell AP mode where the HH unit 12 is involved in a cellular communication and the radio interface 52 that includes the PHY unit 60 of the HH unit is not supporting a cellular communication with user equipment. The active components (e.g., the ones with darker lines) function as discussed with referenced to FIG. 12 to support the HH unit cellular communication and user equipment cellular communication via radio interface 50.

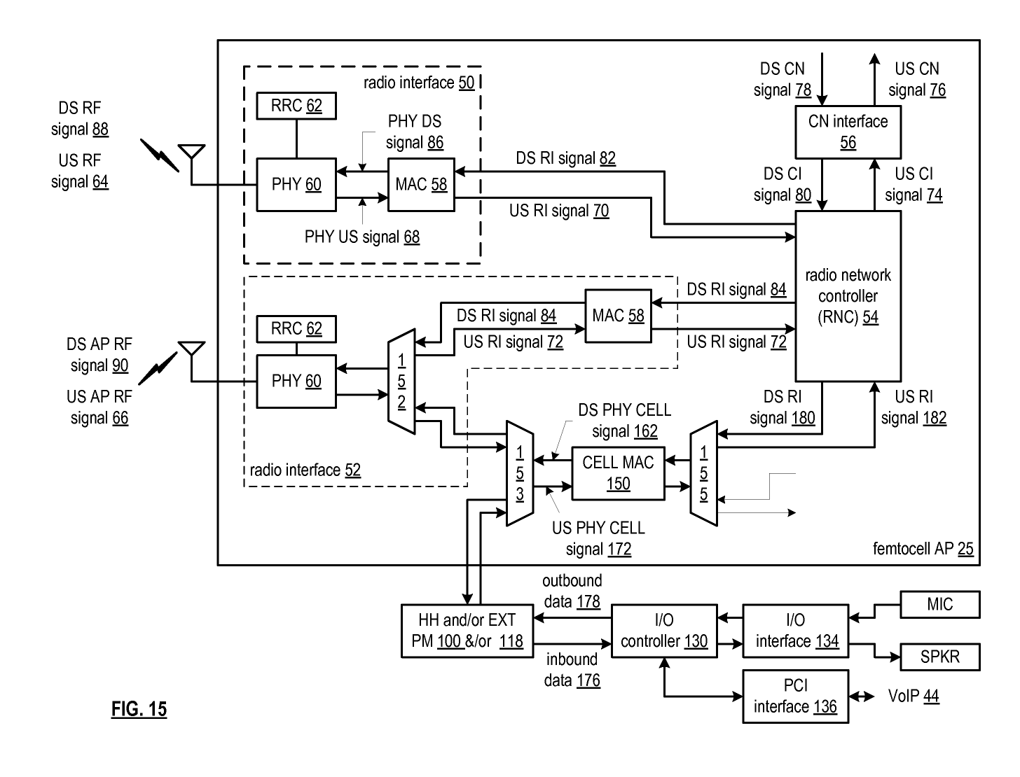

FIG. 15 is a schematic block diagram of another example of a handheld computing unit 12 and an extended computing unit 14 of FIG. 12 in a femtocell AP mode where the HH unit 12 is involved in a cellular communication and the radio interface 52 that includes the PHY unit 60 of the HH unit is not supporting a cellular communication with user equipment. The active components (e.g., the ones with darker lines) function as discussed with referenced to FIG. 12 to support the HH unit cellular communication and user equipment cellular communication via radio interface 50.

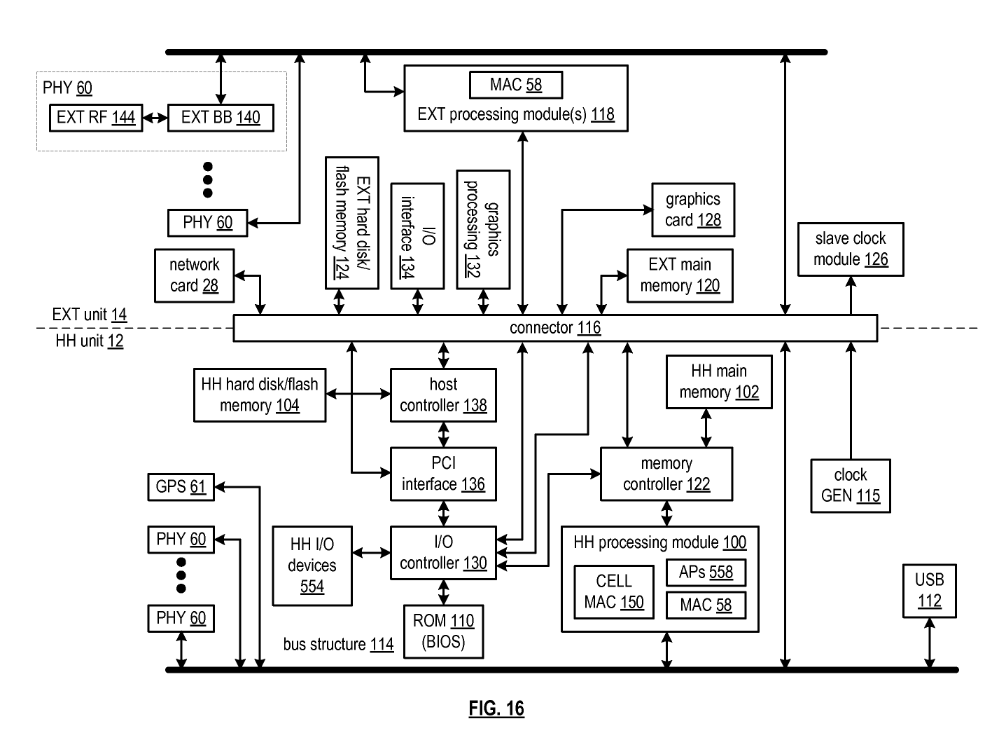

FIG. 16 is a schematic block diagram of another example of a handheld computing unit and an extended computing unit in accordance with the present invention. In particular, a handheld computing unit 12 and extended computing unit 14 are shown in an additional embodiment that includes many similar elements to those previously described that are referred to by common reference numerals. In addition, handheld computing unit 12 includes a global positioning system (GPS) receiver 61, and handheld I/O devices 554 and handheld processing module 100 includes a plurality of applications 558 including a femtocell application and a wireless telephony application that provide user setup, functionality and control of the various functions and features for each of these corresponding modes of operation. In an embodiment of the present invention, the handheld I/O devices include a touch screen, such as an inductive touch screen, a capacitive touch screen, a resistive touch screen or other touch screen or other interactive display device, one or more biometric sensors, a microphone camera and speaker along with a codec for encoding voice signals from the microphone into digital voice signals, a touch screen interface for generating touch screen data from a touch screen in response to the actions of a user, a display driver for driving the display, such as by rendering a color video signal, text, graphics, or other display data, and an audio driver such as an audio amplifier for driving the speaker, for interfacing with the camera or the other I/O devices. It should be noted, that in some embodiments of the present invention, the functionality of extended computing unit 14 and handheld computing 12 can be combined in a single unit that includes the functionality of both devices, but in a portable fashion.

In this embodiment, the handheld computing unit 12 includes multi-level security, including enhanced security for the functions and features used in the femtocell AP mode of operation. In this fashion, if the handheld computing unit 12 were obtained by an unauthorized user, a security application that operates in conjunction with one or more components of the handheld computing unit 12 resists or precludes access to femtocell operability and settings.

In operation, a radio implemented by one or more units PHY 60 communicates with at least one external station in a femtocell access point (AP) mode of operation. A processing module, such as handheld processing module 100, executes a plurality of applications 558 including a femtocell application in the femtocell AP mode of operation and a multi-level security application that authenticates a user of the computing unit and that restricts access to the femtocell application based on the authentication of the user.

In an embodiment of the present invention, the multi-level security application includes a plurality of different levels of security from a most secure level down to a least secure level. The different security levels can be characterized by different security mechanisms, such as any of the following examples:
1. Password or passphrase;
2. Password with temporally enabled pseudorandom key;
3. RFID;
4. Spoken passphrase recognition;
5. Biometric security such as speaker recognition, face recognition, fingerprint identification or other biometric authentication;
6. Shape recognition; and/or
7. Other security mechanisms.
   In addition, one or more security levels can be characterized by different combinations of security mechanisms. In particular, security levels corresponding to enhanced security can be implemented via such combinations. For example, an enhanced security level can employ with password plus fingerprint identification, another enhanced security level can employ RFID plus shape recognition and speaker recognition, and any other combination of two or more security mechanisms. In other examples, enhanced security levels can be characterized by tighter security thresholds for user authentication. For example, a higher correlation threshold can be used for shape recognition, biometric recognition, and/or passphrase recognition when compared with lesser security levels, requiring a tighter match between a candidate security entry and training samples or other exemplars, etc for user authentication. In another example, other security parameters can be changed between higher and lower security levels including the number of incorrect authentication attempts that are tolerated, the time period required for authentication, etc.

In an embodiment of the present invention, the multi-level security application employs a first security level to restrict access to the wireless telephony mode of operation and a second, more enhanced security level, to restrict the access to the femtocell application. Lower security levels can be used to restrict access to games or common office application of the handheld computing unit 12 while an enhanced level or the most enhanced level of security can restrict access to administrative function, a password safe, etc. In one mode of operation, the particular security levels assigned to each particular function or application of the handheld computing unit 12 can be assigned by the user.

The multi-level security application may or may not tolerate one or more unsuccessful authentication attempts, based on the particular security level, after which the multi-level security application declares to a false authentication event and generates a security fault. In the event of a security fault, the multi-level security application can initiates a shutdown of the computer unit, transmits security fault data in the form of an email, text message, voice message or other data in the wireless telephony mode of operation to a security website, to other accounts of the user, or to other sources as specified by the user during setup of the device. In a further mode of operation, the security fault data can include position data generated by the GPA receiver that can be used to track the position of the handheld computing unit 12.

FIG. 17 is a schematic block diagram of an embodiment of a portable device implementing graphical authentication in accordance with the present invention. In particular, a portable device 506 is shown, that includes touch screen, such as an inductive touch screen, capacitive touch screen, resistive touch screen or other touch screen that includes a display screen 508 and that generates touch screen data in response to a user's interaction with the touch screen. The portable device 506 includes one or more processors for executing applications associated with the portable device 506 and that further executes a security application, such as the multi-level security application previously discussed, for authenticating the user to the portable device. For example, the portable device 506 can be an embodiment of handheld computing unit 12 or an embodiment that includes the functionality of both handheld computing unit 12 and extended computing unit 14.

In operation, the security application authenticates the user before providing the user access to the portable device 506. Such access can include access to one or more applications of the portable device 506 such as a femtocell application, wireless telephony application or other application, access to one or more advanced features of the portable device or to personal information, settings or administrative functions of the portable device 506. In an embodiment of the present invention, each time the portable device is turned on, or placed in an active mode from a sleep mode, hibernation or after a period of inactivity, the security application provides display data to the touch screen for displaying a security prompt on the display screen. As shown on display screen 508, the security application displays the security prompt “Enter security code”. In a further example, another security prompt can be presented that more specifically prompts the user to draw the authentication shape.

The security code can be a line drawing or other drawing of a number or letter or a non-alphanumeric symbol, shape, character or other graphic, that is associated with the user and can be used by the security application to authenticate the user to the portable device 506. In the line drawing 500 shown, the authentication shape can include one or more points of self intersection. In the alternative, authentication shapes can be less complex without points were the line drawing intersects itself. In addition, the authentication shape can include multiple line drawings or other drawings including numbers or letters or a non-alphanumeric symbols, shapes, characters or other graphics.

In an embodiment of the present invention, the user is allowed to select their own authentication shape and, through a training routine, provide the security application with training samples, exemplars or other sufficient information so as to allow the security application to recognize future instances of the authentication shape drawn by the user on the touch screen. For example, the user can choose to draw a figure-eight pattern and train the device to recognize the his or her particular rendition of a figure-eight by supplying one or more training samples to the device.

In another embodiment of the present invention, an authentication shape is randomly generated and/or randomly selected from a large number of possible authentication shapes and shown to the user during set up of the portable device 506. The user must mimic the authentication shape at later times in response to the security prompt in order to obtain access to the device. For example, the portable device may randomly select a triangle as the authentication shape for the user and provide an example of how to draw the shape on the screen for the user to mimic, when prompted, in order to gain access to the portable device 506 in the future. It should be noted that, training may also optionally be used to provide the security application with sufficient information so as to allow the security application to recognize future instances of the authentication shape drawn by the user on the touch screen. In the “triangle” example discussed above, the security application can be trained to recognize the particular way that the user draws the triangle.

When the user draws the authentication shape on the touch screen, touch screen data is received from the touch screen in response to the user's interaction with the touch screen. In FIG. 17, the drawing of the authentication shape 500 by the user's finger is indicated by a dashed line. While a finger is shown as a means for interacting with the touch screen, other devices such as a stylus, pen or other object may likewise be used. In an embodiment of the present invention, the security application suppresses the display of the touch screen data so as to not display the authentication shape 500 when it is drawn. In this fashion, other persons that may be observing the user's drawing of the authentication may find it more difficult to interpret what shape is being drawn.

The security application processes the touch screen data to determine when an authentication shape is recognized as being indicated by the touch screen data. In particular, the user is authenticated to the portable device 506 when the authentication shape is recognized as being indicated by the touch screen data. As will be understood, the security application can optionally force the user to change his or her authentication shape periodically, after either expiration of a certain time or after x logins to the portable device 506 or after y unsuccessful logins, etc.

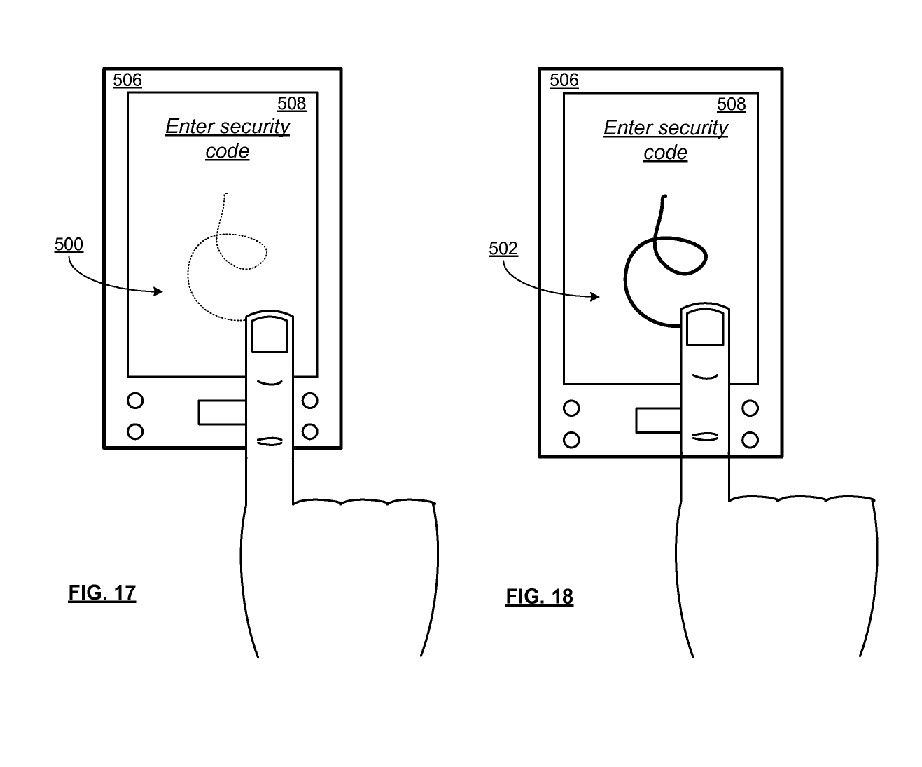

FIG. 18 is a schematic block diagram of another embodiment of a portable device implementing graphical authentication in accordance with the present invention. In particular, another mode of operation of portable device 506 is presented that includes similar elements to those described in conjunction with FIG. 17 that are referred to by common reference numerals. As discussed in conjunction with FIG. 17, when the user draws the authentication shape on the touch screen, touch screen data is received from the touch screen in response to the user's interaction with the touch screen. In this mode of operation however, the security application displays of the touch screen data so as to display the authentication shape 502 when it is drawn. In this fashion, the user of the device has visual feedback of the shape being drawn to aid in more accurate reproduction.

In an embodiment of the present invention, modes of operation corresponding to whether the line drawing of the authentication is displayed or suppressed, are user selectable. In this fashion, users can select to display or suppress the line drawing, based on their preferences, based on their desired level of security or more simply at different times.

FIG. 19 is a schematic block diagram of another embodiment of a portable device implementing graphical authentication in accordance with the present invention. In particular, another mode of operation of portable device 506 is presented that includes similar elements to those described in conjunction with FIGS. 17-18 that are referred to by common reference numerals. As discussed in conjunction with FIGS. 17-18, when the user draws the authentication shape on the touch screen, touch screen data is received from the touch screen in response to the user's interaction with the touch screen. In this mode of operation however, the security application displays of the touch screen data so as to display the authentication shape 501 with limited persistence so as to display only a portion of the line drawing at a time. In the embodiment shown, the solid line indicates the portion of the line drawing 501 that is currently being displayed and the dashed line indicates the portion of the line drawing that was drawn but no longer displayed.

For example, portions of touch screen data can be displayed for some limited persistence time, tₚ, that is less than the amount of time taken to draw the entire line drawing of the authentication shape 501. In another example, the display of the line drawing is allowed to fade linearly, exponentially or via another fading function so as to disappear or substantially disappear gradually after some persistence time tₚ. In this fashion, the user of the device has some visual feedback of the shape being drawn to aid in more accurate reproduction, while not displaying the entire authentication shape, for enhanced security.

In an embodiment of the present invention, modes of operation corresponding to whether the line drawing of the authentication is displayed fully, displayed with limited persistence or suppressed, are user selectable. In this fashion, users can select how to display the line drawing or to suppress the line drawing, based on their preferences, based on their desired level of security or more simply at different times.

FIG. 20 is a schematic block diagram of another embodiment of a portable device implementing graphical authentication in accordance with the present invention. In this embodiment, the security prompt includes a text entry box that allows the user to enter text via a keyboard connected to portable device 506, a keyboard included in portable device 506 or soft keys implemented via the touch screen. In one example, the process of authenticating the user to the portable device requires both the entry and recognition of the authentication shape and the entry of a valid security password in the text entry box. In this fashion, the entry and recognition of the authentication shape adds to the security provided by the password. In the example shown, the security prompt identifies only the password and does not identify that an authentication shape is required, further frustrating the attempts of an unauthorized user to gain access to the portable device 506. In a further example, an additional security prompt can be presented that specifically prompts the user to draw the authentication shape.

The password can be a user-selected password or passphrase that is entered alphanumerically. In an embodiment of the present invention the multi-level security application restricts the access to the femtocell application based on a password that includes a temporally enabled pseudorandom key. For example, a security token, such as SecurID token available from RSA can provide a current pseudorandom key that is concatenated with an additional user password and entered during a limited time period when the temporally enabled pseudorandom key is enabled.

In another embodiment of the present invention, a dummy text entry box can be presented in the security prompt. In particular, the text entry box can accept text input that is ignored when authenticating the user to the portable device—for instance, with authentication being based instead on the entry of an authentication shape as previously discussed. As will be understood, the provision of a dummy text entry box serves to further frustrate attempts of an unauthorized user to gain access to the portable device 506.

It should be noted that the various embodiments discussed in conjunction with FIGS. 17-20 can be included in a single device and presented as different modes of operation. In this fashion, modes with greater or lesser security can be selected by the user, or attached to provide differing levels of security in different circumstances, to access different features, to access different data, etc.

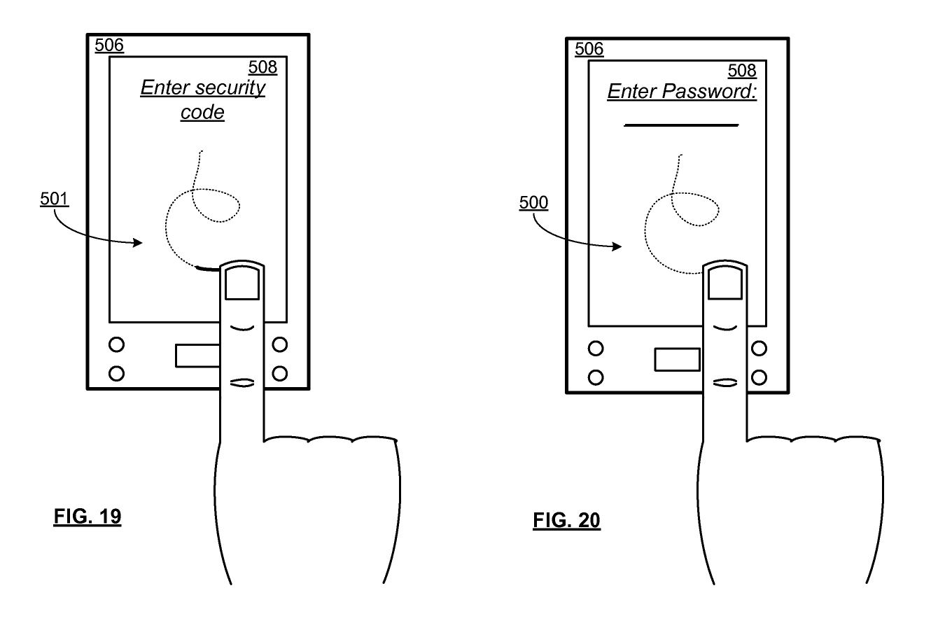

FIGS. 21 and 22 are schematic block diagrams of an embodiment of a portable device implementing a training mode in accordance with the present invention. In particular, portable device 506 includes a security application that recognizes authentication shapes with a user-dependent pattern recognition algorithm, a neural network or other learning algorithm. In the training mode, the user is prompted, via screen display 508 to enter training shapes 510 and 512. The security application processes the touch screen data from each of the training shapes in order to model the authentication shape the user entering, for future recognition in authentication mode.

In an embodiment of the present invention, the training mode prompts the user to enter training shapes until a model is generated that successful recognizes the training shapes in a consistent fashion so as to provide reliable recognition of the authentication shape in the authentication mode.

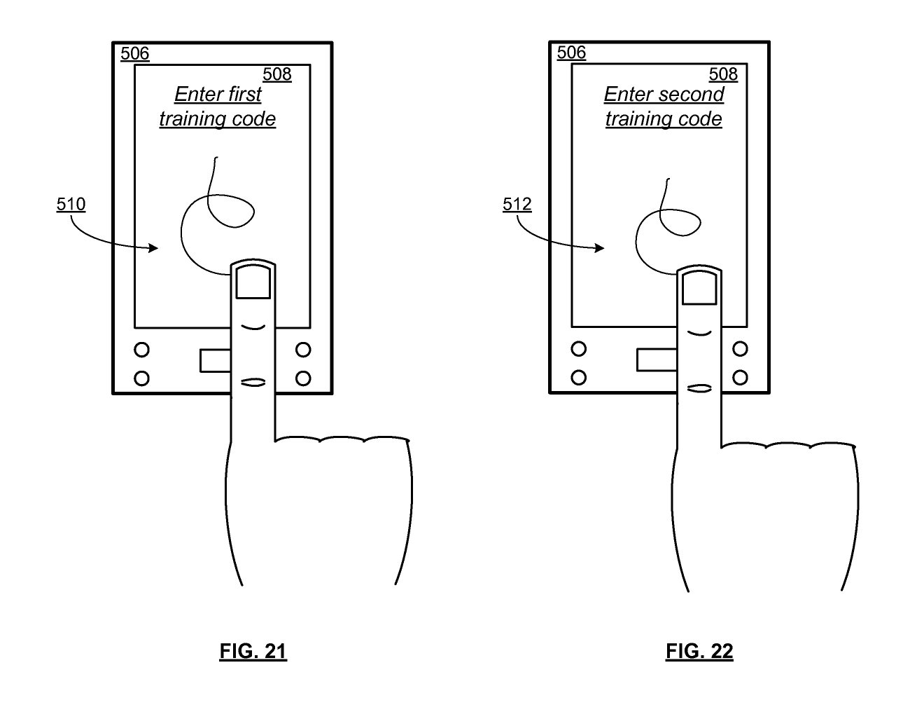

FIG. 23 is a graphical representation of example touch screen data in accordance with the present invention. In this example, the touch screen of portable device 506 generates touch data indicated by the small circles at sample times (t₁, t₂, t₃, . . . t₁₇) in terms of X and Y coordinates. The ith sample, Sᵢ, at time tᵢ, can be represented by:

Sᵢ=(Xtᵢ,Ytᵢ)

where Xtᵢ represents the X coordinate at time tᵢ and where Ytᵢ represents the Y coordinate at time tᵢ. Considering a more generic case, touch screen data includes a set of n samples, [S₁, S₂, S₃, . . . Sₙ].

As discussed in conjunction with FIG. 17, the touch screen data is processing to determine when an authentication shape is recognized as being indicated by the touch screen data. In an embodiment of the present invention, such processing can include preprocessing to extract a plurality of shape descriptors from the drawing such as line and arc segments, Fourier descriptors, or other shape descriptors that describe the authentication shape as a function of the samples. Such preprocessing can generate size and/or orientation dependent shape descriptors for processing by a size and/or orientation dependent pattern recognition algorithm. In the alternative, such preprocessing can generate size and/or orientation independent shape descriptors for processing by a size and/or orientation independent pattern recognition algorithm. Consider a set of k descriptors, [D₁, D₂, D₃, . . . Dₖ], for a particular authentication shape, these descriptors are extracted as a function of the samples, or

[D₁,D₂,D₃, . . . Dₖ]=F[S₁,S₂,S₃, . . . Sₙ]

where F represents a particular descriptor function.

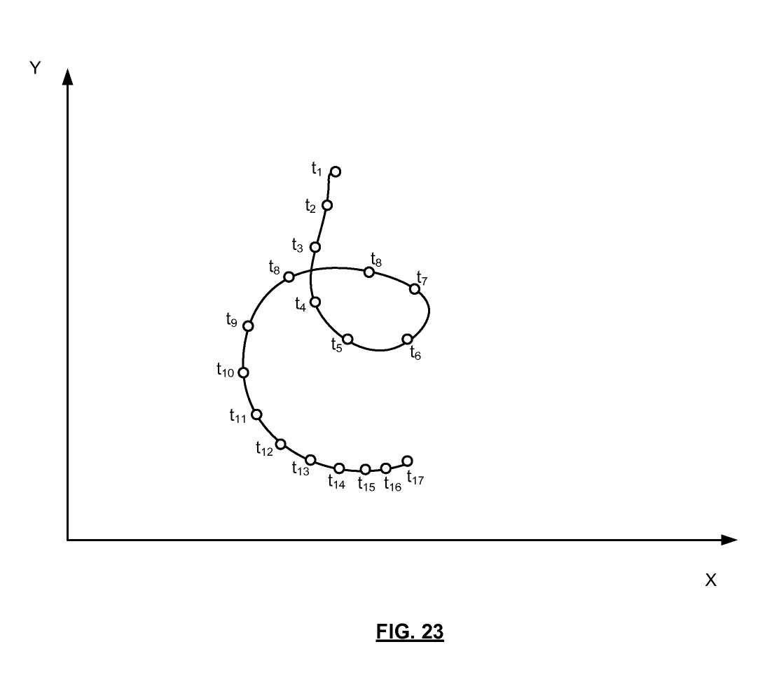

FIG. 24 is a graphical representation of an example velocity profile and stored velocity profile in accordance with the present invention. In particular, processing of the touch screen data can include preprocessing to extract a velocity profile associated with the user's interaction with the touch screen. Considering the sampling of touch screen data described in conjunction with FIG. 23, the velocity Vᵢ associated with a sample Sᵢ can be estimated as:

Vᵢ=SQRT((Xtᵢ−Xtᵢ₋₁)²+(Ytᵢ−Ytᵢ₋₁)²)/(tᵢ−tᵢ₋₁)

In an embodiment of the present invention, the velocity profile can be determined for a set of samples [S₀, S₁, S₂, S₃, . . . Sₙ] as being based on one or more of the estimated velocities [V₁, V₂, V₃, . . . Vₙ].

In an embodiment of the present invention, a stored velocity profile 540 is generated in a training mode, by normalizing the data over a mean time duration tₙ* of the drawing and by fitting the aggregate data collected over one or more training samples to a curve using a curve fitting algorithm. The velocity profile [V₁, V₂, V₃, . . . Vₙ] shown as points 542 corresponding to the user's interaction with the touch screen is compared to the stored velocity profile 540 using and the user is authenticated to the portable device 506 when the velocity profile 542 associated with the user's interaction with the touch screen compares favorably to the stored velocity profile 540. In particular, when the mean difference or aggregated difference between the stored velocity profile 540 and the velocity profile 542 is less than a threshold, and the authentication shape is also authenticated, then the user is authenticated to the portable device.

In this particular embodiment, both shape and velocity profile are required for authentication, meaning that a user must draw a similar shape with a similar velocity to match the training data. In this mode of operation, an unauthorized user that copies the authentication shape, but with a different velocity profile will not authenticated to the portable device 506.

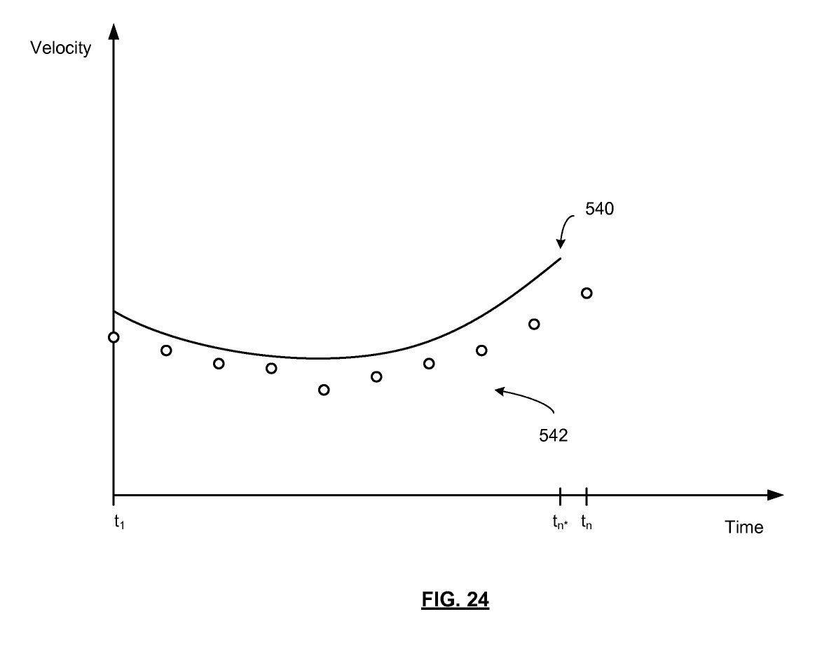

FIG. 25 is a graphical representation of an example normalized velocity profile and stored velocity profile in accordance with the present invention. In this embodiment of the present invention, in this embodiment, the velocity profile [V₁, V₂, V₃, . . . Vₙ] is time normalized to match the mean time duration tₙ* of the stored velocity profile. In this embodiment the user is authenticated to the portable device 506, when the time normalized velocity profile 544 (represented by normalized dots) compares favorably to the stored velocity profile 540.

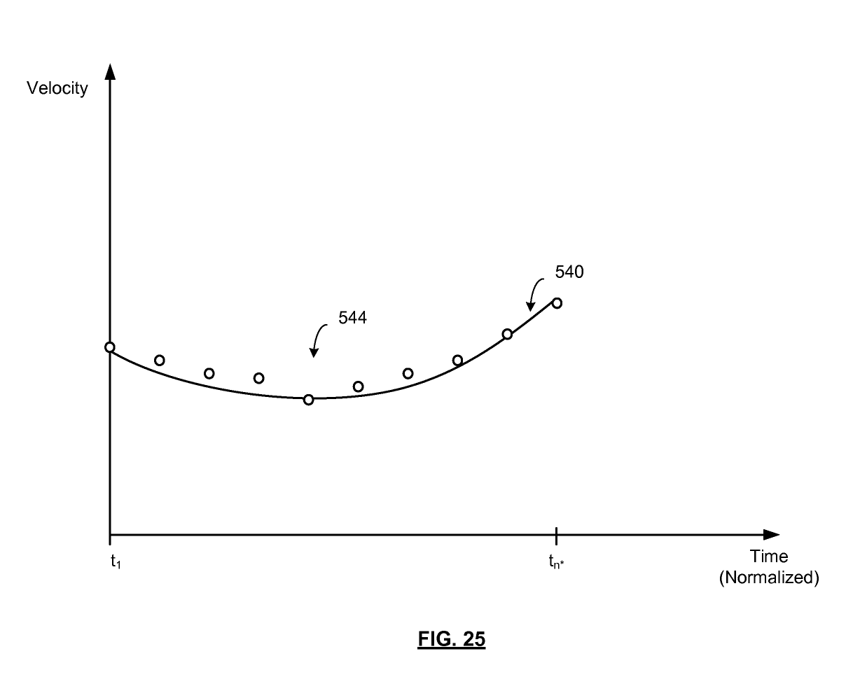

FIG. 26 is a schematic block diagram of security module 525 in accordance with an embodiment of the present invention. In particular, a security module 525 is shown that can optionally be included in handheld computing unit 12 and can be implemented in hardware, software or firmware as part of the multi-level security application previously discussed. Security module 525 includes a preprocessing module 522 for preprocessing touch screen data 520 to generate training data 526 when a training mode is indicated by mode selection signal 524 and further for processing and/or preprocessing touch screen data 520 to generate authentication data 530 when an authentication mode is indicated by mode selection signal 524. For example, preprocessing module 522 can generate size and/or orientation independent shape descriptors, size and/or orientation dependent shape descriptors, velocity profiles, and or other training data 526 and authentication data 530.

In an embodiment of the present invention, the preprocessing module 522, training module 528 and authentication module 532 are implemented via a dedicated or shared processing device or devices. Any such a processing device, for instance, may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The associated memory may be a single memory device or a plurality of memory devices that are either on-chip or off-chip. Such a memory device may be a read-only memory, random access memory, volatile memory, non-volatile memory, static memory, dynamic memory, flash memory, and/or any device that stores digital information. Note that when the preprocessing module 522 training module 528 and authentication module 532 implement one or more of their functions via a state machine, analog circuitry, digital circuitry, and/or logic circuitry, the associated memory storing the corresponding operational instructions for this circuitry is embedded with the circuitry comprising the state machine, analog circuitry, digital circuitry, and/or logic circuitry.

The training data 526 and the authentication data 530 can each include shape descriptors, velocity profiles and or other data generated by processing touch screen data 520 for the creation of training data such as stored data 534 and the recognition of an authentication shape and/or velocity profile in touch screen data via authentication module 532 as previously discussed in conjunction with the operation of the security application.

Authentication module 532 can implement a size or orientation dependent or independent pattern recognition. In an embodiment of the present invention, the security application includes a plurality of operating modes having a corresponding plurality of security levels. For instance, for a first security level of the plurality of levels, an authentication shape is recognized based on size and/or orientation independent shape descriptor. For a second security level of the plurality of levels, the authentication shape can be recognized based on a size and/or orientation dependent shape descriptor.

FIG. 27 is a schematic block diagram of another embodiment of a portable device implementing biometric authentication in accordance with the present invention. As shown, portable device 540, such as handheld computing 12, is shown that includes a biometric sensor, such as fingerprint reader 542. In operation, the biometric sensor that generates biometric data from the user and the multi-level security application restricts the access to the femtocell application, based on the biometric data.

While a fingerprint reader 542 is shown, other biometric sensors can be used in other examples for face recognition, speaker verification, etc. to authenticate a user based on biometric data.

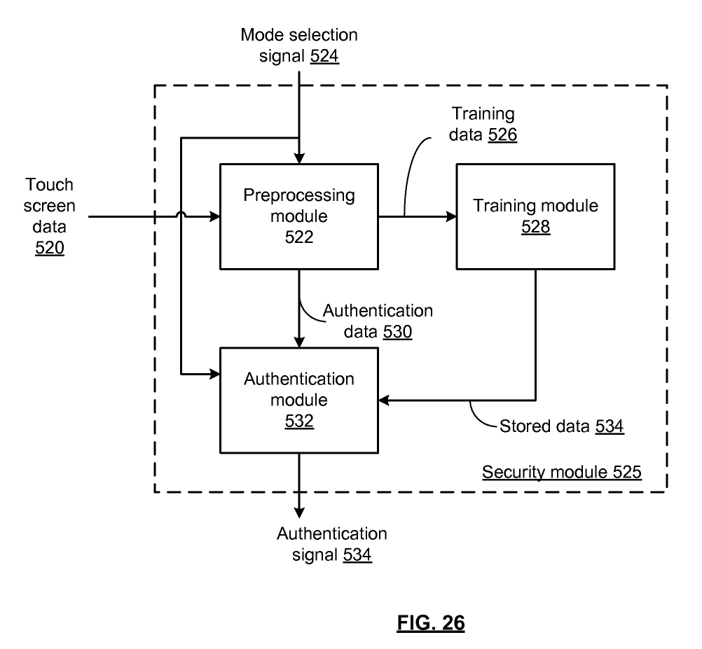

FIG. 28 is a schematic block diagram of security module 545 in accordance with an embodiment of the present invention. In particular, a security module 545 is shown that can optionally be included in handheld computing unit 12 and can be implemented in hardware, software or firmware as part of the multi-level security application previously discussed. Security module 545 includes a preprocessing module 522 for preprocessing biometric data 544 to generate training data 526 when a training mode is indicated by mode selection signal 524 and further for processing and/or preprocessing biometric data 544 to generate authentication data 530 when an authentication mode is indicated by mode selection signal 524.

In an embodiment of the present invention, the preprocessing module 522, training module 528 and authentication module 532 are implemented via a dedicated or shared processing device or devices. Any such a processing device, for instance, may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The associated memory may be a single memory device or a plurality of memory devices that are either on-chip or off-chip. Such a memory device may be a read-only memory, random access memory, volatile memory, non-volatile memory, static memory, dynamic memory, flash memory, and/or any device that stores digital information. Note that when the preprocessing module 522 training module 528 and authentication module 532 implement one or more of their functions via a state machine, analog circuitry, digital circuitry, and/or logic circuitry, the associated memory storing the corresponding operational instructions for this circuitry is embedded with the circuitry comprising the state machine, analog circuitry, digital circuitry, and/or logic circuitry.

In particular, preprocessing module 522, training module 528 and authentication module 532 can operate on biometric data 544 such as fingerprint data, voiceprint data or face identification data to preprocess the biometric data 544 based on the type of biometric data received, to train the security mode 545 to recognize a particular user, and to authenticate the user based on the authentication data generated during future exposures.

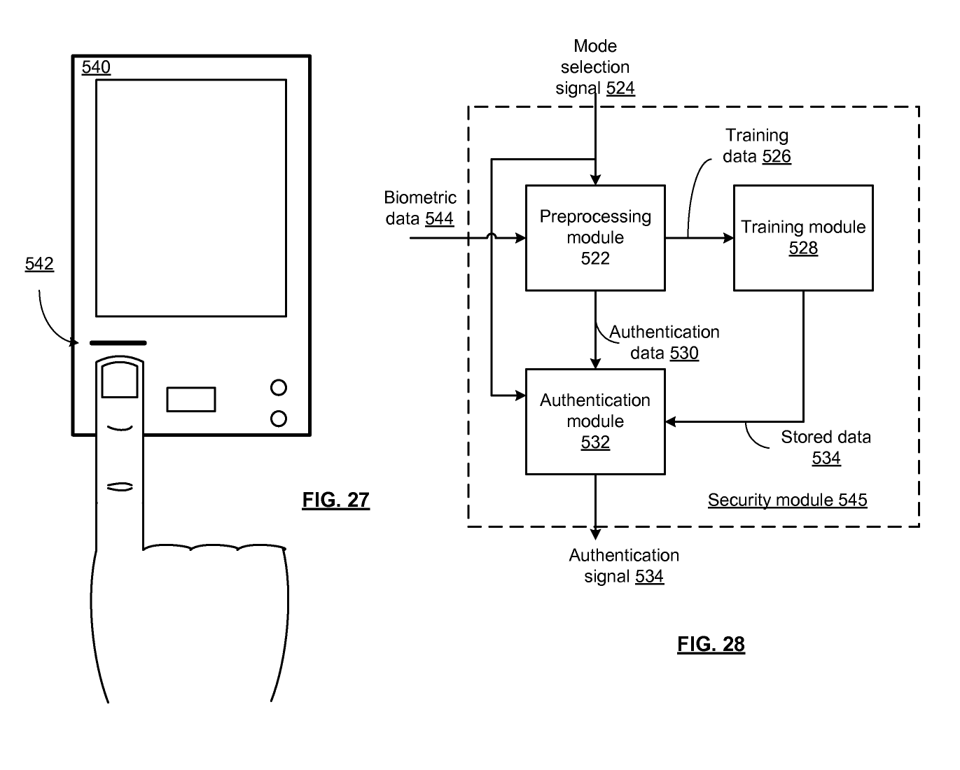

FIG. 29 is a flowchart representation of an embodiment of a method in accordance with the present invention. In particular, a method is shown for use in conjunction with one or more functions and features described in conjunction with FIGS. 1-28. In step 600, at communications are exchanges with least one external station via a radio of a computing unit, in a femtocell access point (AP) mode of operation. In step 602, a plurality of applications are executed via a processor. The applications include a femtocell application in the femtocell AP mode of operation, and a multi-level security application that authenticates a user of the computing unit and that restricts access to the femtocell application based on the authentication of the user.

In an embodiment of the present invention, the multi-level security application includes a first security level and a second security level that is higher than the first security level. Executing the multi-level security application can include employing the second security level to restrict the access to the femtocell application.

The radio can communicate with a wireless telephony network in a wireless telephony mode of operation. Executing the plurality of applications can include executing a wireless telephony application and executing the multi-level security application can include employing the first security level to restrict the access to the wireless telephony application.

In an embodiment of the present invention, executing the multi-level security application can include generating a security fault in response to a false authentication event. Further, executing the wireless telephony application can include transmitting security fault data in response to the security fault.

In an embodiment of the present invention, executing the multi-level security application can include generating a security fault in response to a false authentication event, and initiating a shutdown of the computer unit in response to the security fault. The second security level can restricts the access to the femtocell application, based on a plurality of security mechanisms. Executing the multi-level security application can include restricting the access to the femtocell application based on a password that includes a temporally enabled pseudorandom key.

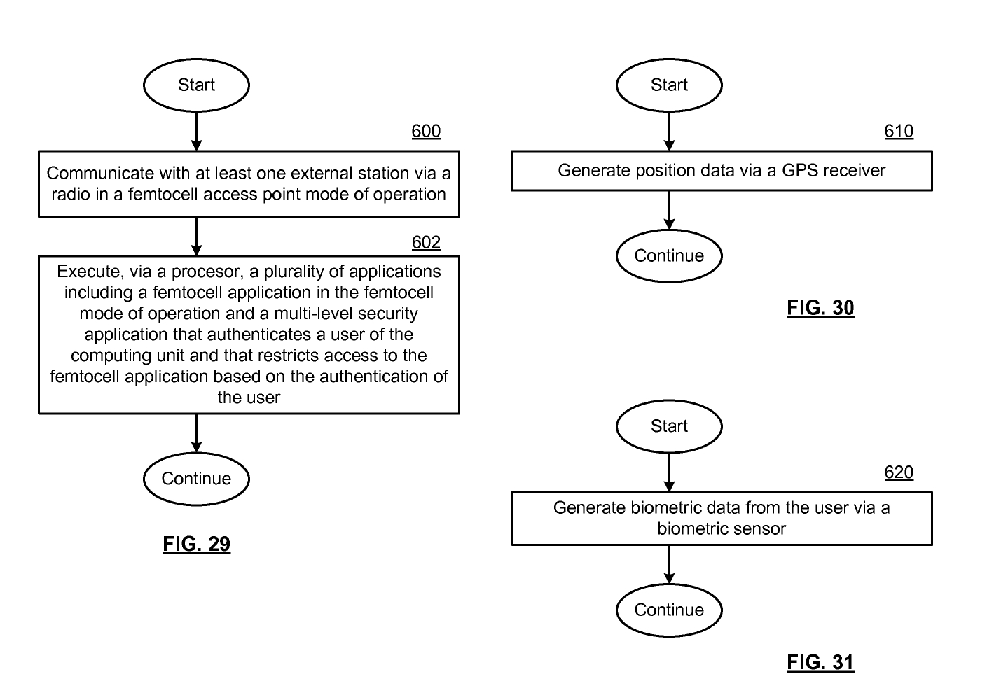

FIG. 30 is a flowchart representation of an embodiment of a method in accordance with the present invention. In particular, a method is shown for use in conjunction with one or more functions and features described in conjunction with FIGS. 1-29. In step 610, position data is generated via a global positioning system (GPS) receiver; and the security fault data includes the position data.

FIG. 31 is a flowchart representation of an embodiment of a method in accordance with the present invention. In particular, a method is shown for use in conjunction with one or more functions and features described in conjunction with FIGS. 1-30. In step 620, biometric data is generated from the user via a biometric sensor and the executing the multi-level security application includes restricting the access to the femtocell application, based on the biometric data.

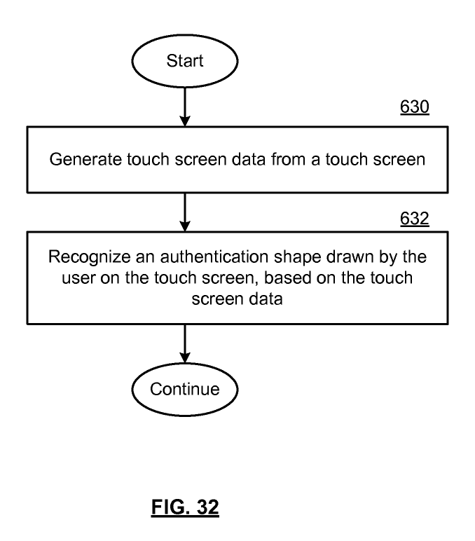

FIG. 32 is a flowchart representation of an embodiment of a method in accordance with the present invention. In particular, a method is shown for use in conjunction with one or more functions and features described in conjunction with FIGS. 1-31. In step 630, touch screen data is generated from a touch screen. In step 632, an authentication shape drawn by the user on the touch screen, is recognized based on the touch screen data. Executing the multi-level security application can include restricting the access to the femtocell application, based on the recognition of the authentication shape.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “operably coupled to”, “coupled to”, and/or “coupling” includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

What is claimed is:

1. A computing unit comprises:
a radio that communicates with at least one external station in a femtocell access point (AP) mode of operation;
a processing module, coupled to the radio interface, that executes a plurality of applications including:
a femtocell application in the femtocell AP mode of operation; and
a multi-level security application that authenticates a user of the computing unit and that restricts access to the femtocell application based on the authentication of the user.

2. A computing unit of claim 1 wherein the multi-level security application includes a first security level and a second security level that is higher than the first security level; and
wherein the multi-level security application employs the second security level to restrict the access to the femtocell application.

3. A computing unit of claim 2 wherein the radio communicates with a wireless telephony network in a wireless telephony mode of operation;
wherein the plurality of applications include a wireless telephony application; and
wherein the multi-level security application employs the first security level to restrict the access to the wireless telephony application.

4. The computer unit of claim 3 wherein the multi-level security application generates a security fault in response to a false authentication event;
and wherein the radio transmits security fault data in the wireless telephony mode of operation in response to the security fault.

5. The computer unit of claim 4 wherein the computing unit further comprises:
a global positioning system (GPS) receiver that generates position data;
and wherein the security fault data includes the position data.

6. The computer unit of claim 3 wherein the multi-level security application generates a security fault in response to a false authentication event;
and wherein the multi-level security application initiates a shutdown of the computer unit in response to the security fault.

7. A computing unit of claim 2 wherein the second security level restricts the access to the femtocell application, based on a plurality of security mechanisms.

8. The computer unit of claim 1 wherein the computing unit further comprises:
a biometric sensor that generates biometric data from the user;
wherein the multi-level security application restricts the access to the femtocell application, based on the biometric data.

9. The computer unit of claim 1 wherein the computing unit further comprises:
a touch screen;
wherein the multi-level security application restricts the access to the femtocell application, based on recognizing an authentication shape drawn by the user on the touch screen.

10. The computer unit of claim 1 wherein the multi-level security application restricts the access to the femtocell application based on a password that includes a temporally enabled pseudorandom key.

11. A method for use in a computing unit, the method comprises:
communicating with at least one external station via a radio, in a femtocell access point (AP) mode of operation;
executing, via a processor, a plurality of applications including:
a femtocell application in the femtocell AP mode of operation; and
a multi-level security application that authenticates a user of the computing unit and that restricts access to the femtocell application based on the authentication of the user.

12. A method of claim 11 wherein the multi-level security application includes a first security level and a second security level that is higher than the first security level; and
wherein executing the multi-level security application includes employing the second security level to restrict the access to the femtocell application.

13. A method of claim 12 wherein the radio communicates with a wireless telephony network in a wireless telephony mode of operation;
wherein executing the plurality of applications includes executing a wireless telephony application; and
wherein executing the multi-level security application includes employing the first security level to restrict the access to the wireless telephony application.

14. The method of claim 13 wherein executing the multi-level security application includes generating a security fault in response to a false authentication event; and
wherein executing the wireless telephony application includes transmitting security fault data in response to the security fault.

15. The method of claim 14 further comprising:
generating position data via a global positioning system (GPS) receiver; and
wherein the security fault data includes the position data.

16. The method of claim 13 wherein executing the multi-level security application includes:
generating a security fault in response to a false authentication event, and
initiating a shutdown of the computer unit in response to the security fault.

17. A method of claim 12 wherein the second security level restricts the access to the femtocell application, based on a plurality of security mechanisms.

18. The method of claim 11 further comprising:
generating biometric data from the user via a biometric sensor;
wherein executing the multi-level security application includes restricting the access to the femtocell application, based on the biometric data.

19. The method of claim 11 further comprising:
generated touch data from a touch screen;
recognizing an authentication shape drawn by the user on the touch screen, based on the touch screen data;
wherein executing the multi-level security application includes restricting the access to the femtocell application, based on the recognition of the authentication shape.

20. The method of claim 11 wherein executing the multi-level security application includes restricting the access to the femtocell application based on a password that includes a temporally enabled pseudorandom key.
